(19) United States
(12) Patent Application Publication
(10) Pub. No.: US 2025/0344634 A1
(43) Pub. Date: Nov. 13, 2025

(54) GROUND-WORKING MACHINE DYNAMIC COUNTERBALANCE

(71) Applicant: The Toro Company, Bloomington, MN (US)

(72) Inventors: John R. Van Beek, Savage, MN (US); Richard Tyler Havlik, Waconia, MN (US)

(21) Appl. No.: 18/860,179

(22) PCT Filed: Apr. 26, 2023
(86) PCT No.: PCT/US2023/019892

§ 371 Date: Oct. 25, 2024

Related U.S. Application Data
(60) Provisional application No. 63/335,075, filed on Apr. 26, 2022.

(51) Int. Cl. A01D 34/00; A01D 34/66; A01D 34/86; A01D 101/00

(52) U.S. Cl. CPC A01D 34/006; A01D 34/66; A01D 34/86; A01D 2101/00

(57) ABSTRACT

Embodiments herein relate to a dynamic counterbalance system for a ground-working machine having vehicle ground-engaging rotatable members configured to contact a ground surface, working assemblies, and connection assemblies, wherein each connection assembly attaches one working assembly to the vehicle. Each connection assembly is configured to apply a counterbalance pressure to the one working assembly, wherein the counterbalance pressure shifts weight from the working assembly ground-engaging rotatable members to the vehicle ground-engaging rotatable members based in output from a slope sensor, wherein the working assembly ground-engaging rotatable members remain in contact with a ground surface while the determined counterbalance pressure of the determined counterbalance value is applied to the particular working assembly.

This application is being filed as a PCT International Patent application on Apr. 25, 2023 in the name of The Toro Company, a U.S. national corporation, applicant for the designation of all countries and John R. Van Beek, a U.S. Citizen, and Richard Tyler Havlik, a U.S. Citizen, inventors for the designation of all countries, and claims priority to U.S. Provisional Patent Application No. 63/335,075, filed Apr. 26, 2022, the contents of which are herein incorporated by reference in its/their entirety/entireties.

### FIELD

Embodiments herein relate to ground-working machines, and more specifically to ground-working machines having dynamic counterbalance.

### BACKGROUND

Ground-working machines with multiple working assemblies allow an operator to traverse a large area in a shorter amount of time, especially for contoured terrain. When in the working position, the working assemblies tend to transfer most of their weight directly to the ground. In some cases, this can adversely affect the traction of the ground-working machine vehicle. Accordingly, there are times when it would be desirable to transfer at least a portion of the weight of the working assemblies back to the vehicle to put more downforce on the vehicle thereby increasing its traction.

### SUMMARY

In a first aspect, a ground-working machine includes a vehicle which includes a plurality of vehicle ground-engaging rotatable members configured to contact a ground surface, a plurality of working assemblies, each working assembly including a ground-working unit and a plurality of working assembly ground-engaging rotatable members configured to contact the ground surface, and a plurality of connection assemblies, wherein each connection assembly attaches one working assembly to the vehicle, each connection assembly having a first end attached to the one working assembly and a second end attached to the vehicle, each connection assembly configured to apply a counterbalance pressure to the one working assembly, wherein the counterbalance pressure shifts weight from the working assembly ground-engaging rotatable members to the vehicle ground-engaging rotatable members. The ground-working machine further includes a control system including a slope sensor configured to output a slope value indicating a slope of the ground-working machine with respect to a horizontal reference plane, wherein the control system can be configured to: i. based on the slope value, determine whether to apply a counterbalance pressure or change an already-applied counterbalance pressure to each of the working assemblies via its connection assembly, ii, if a determination can be made to apply or change a counterbalance pressure at a particular working assembly, determine a counterbalance value based on the slope value and a location of the particular working assembly with respect to the vehicle, and iii, apply a counterbalance pressure of the determined counterbalance value via a connection assembly to each particular working assembly for which a determination was made to apply or change a counterbalance pressure, wherein the working assembly ground-engaging rotatable members remain in contact with a ground surface while the determined counterbalance pressure of the determined counterbalance value can be applied to the particular working assembly.

In a second aspect, in addition to one or more of the preceding or following aspects, or in the alternative to some aspects, each connection assembly includes a connector arm attached to the working assembly at a first end and to the vehicle at a second end, a fluid power actuator attached to the connector arm at a first end and to the vehicle at a second end, a counterbalance valve operatively connected to the fluid power actuator and configured to apply the counterbalance pressure to the one working assembly via the fluid power actuator, and a lift valve operatively connected to the fluid power actuator and configured to apply a lift pressure to the one working assembly to move the connection assembly to a raised position not contacting the ground surface, and wherein the ground-working machine further includes a lift interface configured to receive input from a user requesting movement of one or more of the working assemblies to a raised position.

In a third aspect, in addition to one or more of the preceding or following aspects, or in the alternative to some aspects, upon reading a slope value that can be at or above a threshold slope, the control system can be further configured to set an uphill counterbalance value for an uphill one of the plurality of working assemblies disposed above the vehicle on the slope, and set a downhill counterbalance pressure for a working assembly disposed below the vehicle on the slope, wherein the uphill counterbalance value can be higher than the downhill counterbalance pressure.

In a fourth aspect, in addition to one or more of the preceding or following aspects, or in the alternative to some aspects, the threshold slope can be zero.

In a fifth aspect, in addition to one or more of the preceding or following aspects, or in the alternative to some aspects, the threshold slope the threshold slope angle can be greater than or equal to two degrees with respect to a horizontal reference plane.

In a sixth aspect, in addition to one or more of the preceding or following aspects, or in the alternative to some aspects, a first working assembly of the plurality of working assemblies can be disposed left of a lateral center of the vehicle, and wherein a second working assembly of the plurality of working assemblies can be disposed right of a lateral center of the vehicle.

In a seventh aspect, in addition to one or more of the preceding or following aspects, or in the alternative to some aspects, the control system can be configured to read a lateral slope value sensed by the slope sensor and set a downhill counterbalance value for a working assembly disposed vertically beneath the vehicle on the lateral slope and set an uphill counterbalance value for a working assembly disposed vertically above the vehicle on the lateral slope, wherein the uphill counterbalance value can be higher than the downhill counterbalance value.

In an eighth aspect, in addition to one or more of the preceding or following aspects, or in the alternative to some aspects, the control system can include a counterbalance interface configured to receive a counterbalance setting from a user, wherein the counterbalance setting determines a dynamic counterbalance range.

In a ninth aspect, in addition to one or more of the preceding or following aspects, or in the alternative to some aspects, the dynamic counterbalance range includes a minimum counterbalance value and a maximum counterbalance value, wherein the minimum counterbalance value can be determined by the counterbalance setting.

In a tenth aspect, in addition to one or more of the preceding or following aspects, or in the alternative to some aspects, the counterbalance setting can include a selection from a low counterbalance setting and a high counterbalance setting, wherein the low counterbalance setting can have a lower minimum counterbalance value than the high counterbalance setting, and wherein the low counterbalance setting and the high counterbalance setting have the same maximum counterbalance value.

In an eleventh aspect, in addition to one or more of the preceding or following aspects, or in the alternative to some aspects, the minimum counterbalance value can be greater than zero.

In a twelfth aspect, in addition to one or more of the preceding or following aspects, or in the alternative to some aspects, the control system further can include a global positioning system (GPS) device, wherein the control system can be configured to: receive information on at least one of: topography of the ground surface, ground speed, and heading data from the GPS device, and based on the received information, determine whether to apply a counterbalance pressure or change the already-applied counterbalance pressure to each of the working assemblies.

In a thirteenth aspect, in addition to one or more of the preceding or following aspects, or in the alternative to some aspects, the control assembly can be configured to receive a longitudinal slope value and lateral slope value from the slope sensor.

In a fourteenth aspect, in addition to one or more of the preceding or following aspects, or in the alternative to some aspects, each connection assembly can be configured to raise the one working assembly from a working position in which the working assembly ground-engaging rotatable members remain in contact with a ground surface to a raised position in which the working assembly ground-engaging rotatable members can be raised above the ground surface.

In a fifteenth aspect, in addition to one or more of the preceding or following aspects, or in the alternative to some aspects, the working assembly ground-engaging rotatable members can be configured to follow the ground surface independently of the vehicle ground-engaging rotatable members.

In a sixteenth aspect, in addition to one or more of the preceding or following aspects, or in the alternative to some aspects, each connection assembly can be further configured to apply a downward pressure to the one working assembly, wherein the downward pressure shifts weight from the vehicle ground-engaging rotatable members to the working assembly ground-engaging rotatable members.

In a seventeenth aspect, in addition to one or more of the preceding or following aspects, or in the alternative to some aspects, the slope sensor can be configured to output a time series of slope values and the control system can be configured to calculate a rolling average slope value over the time series of slope values.

In an eighteenth aspect, a machine can include a vehicle including a plurality of vehicle ground-engaging rotatable members configured to contact a ground surface, a first working assembly disposed to the left of a lateral center of the vehicle and including a plurality of first working assembly ground-engaging rotatable members configured to contact the ground surface, a first connection assembly connecting the first working assembly to the vehicle and configured to apply a first counterbalance pressure to the first working assembly, wherein the first counterbalance pressure shifts weight from the first working assembly ground-engaging rotatable members to the vehicle ground-engaging rotatable members, a second working assembly disposed to the right of the lateral center of the vehicle and including a plurality of second working assembly ground-engaging rotatable members configured to contact the ground surface, a second connection assembly connecting the second working assembly to the vehicle and configured to apply a second counterbalance pressure to the second working assembly, wherein the second counterbalance pressure shifts weight from the second cutting assembly ground-engaging rotatable members to the vehicle ground-engaging rotatable members, a control system can include a slope sensor. The control system can be configured to read a slope value from the slope sensor, determine a first counterbalance value for the first working assembly, determine a second counterbalance value for the second working assembly, set the first counterbalance pressure applied to the first working assembly at the first counterbalance value, set the second counterbalance pressure applied to the second working assembly at the second counterbalance value. The counterbalance values can be determined as a function of the slope value and the location of the particular working assembly with respect to the vehicle, and wherein each counterbalance value falls within a counterbalance range, and wherein the first cutting assembly and the second cutting assembly remain in contact with a ground surface over the counterbalance range.

In a nineteenth aspect, in addition to one or more of the preceding or following aspects, or in the alternative to some aspects, each connection assembly includes a connector arm attached to the working assembly at a first end and to the vehicle at a second end, a fluid power actuator attached to the connector arm at a first end and to the vehicle at a second end, a counterbalance valve operatively connected to the fluid power actuator and configured to apply the counterbalance pressure to the one working assembly via the fluid power actuator, and a lift valve operatively connected to the fluid power actuator and configured to apply a lift pressure to the one working assembly to move the connection assembly to a raised position not contacting the ground surface, and wherein the ground-working machine further includes a lift interface configured to receive input from a user requesting movement of one or more of the working assemblies to a raised position.

In a twentieth aspect, a method of operating a ground-working machine involves a machine including a vehicle and a plurality of working assemblies, each working assembly operatively connected to the vehicle by a connection assembly, wherein each connection assembly can be configured to apply a counterbalance pressure to the connected working assembly, wherein the counterbalance pressure shifts weight from the working assembly ground-engaging rotatable members to the vehicle ground-engaging rotatable members. The method includes receiving a counterbalance setting on a counterbalance user interface, setting a minimum counterbalance value, wherein the minimum counterbalance value can be determined by the counterbalance setting, reading a longitudinal slope value and a lateral slope value from the slope sensor, and determining a counterbalance value for each working assembly based on at least the longitudinal slope value and the lateral slope value and based on a location of the particular working assembly with respect to the vehicle, setting the counterbalance pressure applied to each working assembly to the determined counterbalance value for the particular working assembly, wherein the minimum counterbalance value and the maximum counterbalance value span a counterbalance range, and wherein the working assembly ground-engaging rotatable members remain in contact with a ground surface over the counterbalance range.

In a twenty-first aspect, a method of operating a ground-working machine, the machine can include a vehicle and a plurality of working assemblies, each working assembly operatively connected to the vehicle by a connection assembly. The method can include reading a longitudinal slope value and a lateral slope value from the slope sensor. The method can include responsive to at least the reading of the lateral slope value, determining an operational parameter related to at least one of the working assemblies. Determining the operational parameter can include at least one of determining a counterbalance pressure applied to each working assembly and a lateral shift value applied to each of the working assemblies.

Determining the counterbalance pressure applied to each working assembly includes receiving a counterbalance setting on a counterbalance user interface, wherein each connection assembly can be configured to apply the counterbalance pressure to the connected working assembly, wherein the counterbalance pressure shifts weight from the working assembly ground-engaging rotatable members to the vehicle ground-engaging rotatable members. Determining the counterbalance pressure applied to each working assembly includes setting a minimum counterbalance value, wherein the minimum counterbalance value can be determined by the counterbalance setting. Determining the counterbalance pressure applied to each working assembly includes determining a counterbalance value for each working assembly based on at least the longitudinal slope value and the lateral slope value and based on a location of the particular working assembly with respect to the vehicle. Determining the counterbalance pressure applied to each working assembly includes setting the counterbalance pressure applied to each working assembly to the determined counterbalance value for the particular working assembly, wherein the minimum counterbalance value and the maximum counterbalance value span a counterbalance range, wherein the working assembly ground-engaging rotatable members remain in contact with a ground surface over the counterbalance range.

Determining a lateral shift value of at least one working assembly further includes determining the lateral shift value from a range of lateral shift values for each working assembly based on at least the lateral slope value. Determining a lateral shift value of at least one working assembly further includes laterally shifting the position of each working assembly with respect to the longitudinal axis of the vehicle to the determined lateral shift value, wherein each of the possible lateral shift values falls within a lateral shifting range.

In a twenty-second aspect, in addition to one or more of the preceding or following aspects, or in the alternative to some aspects, further can include upon reading a lateral slope value that can be at or above a threshold slope, laterally shifting each working assembly uphill with respect to the vehicle.

In a twenty-third aspect, in addition to one or more of the preceding or following aspects, or in the alternative to some aspects, further can include laterally shifting each working assembly by the same amount with respect to the longitudinal axis of the vehicle.

In a twenty-fourth aspect, in addition to one or more of the preceding or following aspects, or in the alternative to some aspects, wherein each connection assembly can be connected to a carrier frame, wherein the carrier frame can be configured to be laterally displaced relative to a support frame which can be rigidly attached to the vehicle, and wherein laterally shifting the position of each working assembly includes laterally shifting the carrier frame with respect to the support frame.

In a twenty-fifth aspect, in addition to one or more of the preceding or following aspects, or in the alternative to some aspects, the carrier frame can be configured to be laterally displaced relative to the support frame using an electrically controlled fluid power actuator.

In a twenty-sixth aspect, in addition to one or more of the preceding or following aspects, or in the alternative to some aspects, further can include: reading a slope value that can be at or above a threshold slope value, setting an uphill counterbalance value for an uphill one of the plurality of working assemblies disposed above the vehicle on the slope, and setting a downhill counterbalance pressure for a working assembly disposed below the vehicle on the slope, wherein the uphill counterbalance value can be higher than the downhill counterbalance pressure.

In a twenty-seventh aspect, in addition to one or more of the preceding or following aspects, or in the alternative to some aspects, the threshold slope can be zero. In a twenty-eighth aspect, in addition to one or more of the preceding or following aspects, or in the alternative to some aspects, the threshold slope can be greater than or equal to two degrees with respect to a horizontal reference plane. In a twenty-ninth aspect, in addition to one or more of the preceding or following aspects, or in the alternative to some aspects, a first working assembly of the plurality of working assemblies can be disposed left of a lateral center of the vehicle, and wherein a second working assembly of the plurality of working assemblies can be disposed right of a lateral center of the vehicle.

In a thirtieth aspect, in addition to one or more of the preceding or following aspects, or in the alternative to some aspects, the method can further include reading a lateral slope value sensed by the slope sensor, setting a downhill counterbalance value for a working assembly disposed vertically beneath the vehicle on the lateral slope, and setting an uphill counterbalance value for a working assembly disposed vertically above the vehicle on the lateral slope, wherein the uphill counterbalance value can be higher than the downhill counterbalance value.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of a ground-working machine in accordance with various embodiments herein.

FIG. 2 is front view of the ground-working machine of FIG. 1 in accordance with various embodiments herein.

FIG. 3 is a front view of the ground-working machine of FIG. 1 in accordance with various embodiments herein.

FIG. 4 is a top view of the ground-working machine of FIG. 1 in accordance with various embodiments herein.

FIG. 5 is a top view of an alternative embodiment of a ground-working machine in accordance with various embodiments herein.

FIG. 6 is a perspective view of a working assembly in accordance with various embodiments herein.

FIG. 7 is a front view of a connection assembly in accordance with various embodiments herein.

FIG. 8 is a side view of a connection assembly in accordance with various embodiments herein.

FIG. 9 is a schematic diagram of a hydraulic system for a ground-working machine in accordance with various embodiments herein.

FIG. 10 is a schematic diagram of a counterbalance system in accordance with various embodiments herein.

FIG. 11 is a schematic diagram of a ground-working machine on a ground surface in accordance with various embodiments herein.

FIG. 12 is a schematic view of a user interface in accordance with various embodiments herein.

FIG. 13 is a method of operating a ground-working machine in accordance with various embodiments herein.

FIG. 14 is a schematic diagram of a counterbalance system example for a ground-working machine according to various embodiments herein.

FIG. 15 is a schematic top view of a ground-working machine according to various embodiments herein.

FIG. 16 is a schematic top view of a ground-working machine according to various embodiments herein.

FIG. 17 is a schematic front view of a ground-working machine according to various embodiments herein.

FIG. 18 is a schematic front view of a ground-working machine according to various embodiments herein.

While embodiments are susceptible to various modifications and alternative forms, specifies thereof have been shown by way of example and drawings and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

A ground-working machine can include a vehicle, a plurality of working assemblies, and a plurality of connection assemblies configured to connect each working assembly to the vehicle. As mentioned above, there are times when it would be desirable to transfer at least a portion of the weight of the working assemblies back to the vehicle to put more downforce on the vehicle, thereby increasing its traction. One such time is when the ground-working machine is traversing a sloped surface. Accordingly various embodiments herein describe a ground-working machine configured to dynamically adjust the counterbalance pressure applied to each of its working assemblies. The counterbalance pressure applied to a working assembly can shift weight from the working assembly to the vehicle. The counterbalance pressure can be dynamically adjusted based on a number of factors, including at least one slope of the vehicle with respect to a horizontal reference plane.

In various embodiments, the ground-working machine can include a slope sensor and a control system. Based on the slope value received from the slope sensor, the control system is configured to determine whether to apply a counterbalance pressure or change an already-applied counterbalance pressure to each of the working assemblies via its connection assembly. If a determination is made to apply or change a counterbalance pressure at a particular working assembly, the control system is configured to determine a counterbalance value based on the slope value and a location of the particular working assembly with respect to the vehicle. The control system is configured to apply a counterbalance pressure of the determined counterbalance value via a connection assembly to each particular working assembly for which a determination was made to apply or change a counterbalance pressure. In various embodiments, the working assembly ground-engaging rotatable members of each working assembly remain in contact with the ground surface while the determined counterbalance pressure is applied to the working assemblies.

### Ground-Working Machine

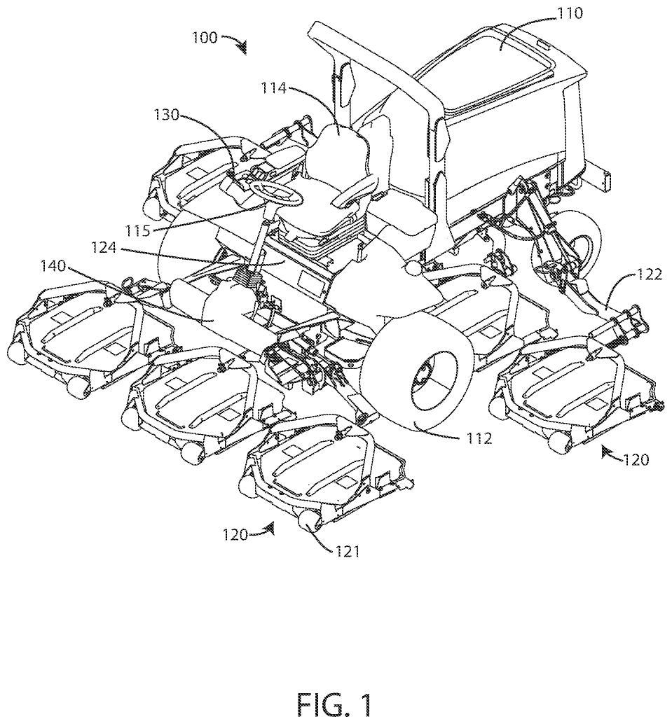

Referring now to FIG. 1, a perspective view of a ground-working machine is shown in accordance with various embodiments herein. In the example of FIG. 1, the ground-working machine 100 is a mower configured to cut grass on a turf surface. In other examples, the ground-working machine 100 can be configured for mowing other plants, spraying, debris collection, raking, aerating, or the like.

The ground-working machine 100 includes a vehicle 110 operably connected by one or more connection assemblies 122 to a plurality of working assemblies 120, also referred to as ground-working assemblies. In various embodiments, the connection assemblies 122 are in communication with a hydraulic system 124 disposed in the vehicle 110.

In the example of FIG. 1, the vehicle 110 is a traction vehicle having vehicle ground-engaging rotatable members 112. The vehicle 110 can have an operator seat 114 and operator controls, such as a steering wheel 115 and a user interface 130. The vehicle 110 further includes many additional internal and external elements, such as an engine, transmission, etc. (not shown). The operator seat 114 faces toward a front 140 of the vehicle 110. The front 140 is in the direction of most typical forward motion from the operator seat 114.

The vehicle 110 rides on two or more vehicle ground-engaging rotatable members 112. In the example of FIG. 1, the vehicle 110 has four vehicle ground-engaging rotatable members 112, but in alternative examples the vehicle can have two, three, five or more vehicle ground-engaging rotatable members. The vehicle ground-engaging rotatable members 112 contact the ground independently of the working assemblies 120.

The ground-working machine 100 is provided with multiple working assemblies 120. In the example of FIG. 1, the ground-working machine 100 is provided with seven working assemblies 120. In alternative examples, the ground-working machine 100 could be provided with fewer working assemblies or more working assemblies 120, such as a single working assembly, two working assemblies, three working assemblies, five working assemblies or eight or more working assemblies. In the example of FIG. 1, the working assemblies 120 are substantially similar to each other. However, it is possible for multiple types of working assembly 120 to be associated with a single vehicle 110.

In various embodiments, the working assemblies 120 can be distributed in a gang configuration. In the example of FIG. 1, vehicle 110 carries seven working assemblies 120 in a 3-4 gang configuration comprising a front row of three working assemblies followed by a rear row of four working assemblies (only two of which can be seen in FIG. 1). In various embodiments, the working assemblies 120 in the rear row are placed to cover the gaps between the working assemblies in the front row.

In the example of FIG. 1, the working assemblies 120 are rotary ground cutting working assemblies, each having a blade (not shown) that rotates around a substantially vertical axis. In alternative embodiments, the working assemblies 120 can incorporate a reel cutting unit, a disc cutting unit, a flail cutting unit, or another type of cutting unit. In further embodiments, the working assemblies 120 can be configured for spraying, debris collection, raking, or aerating, or the like.

In various embodiments, each working assembly 120 can have two or more working assembly ground-engaging rotatable members 121. The working assembly ground-engaging rotatable members 121 can follow the ground surface independently from the vehicle ground-engaging rotatable members 112. In various embodiments, each working assembly is configured to be driven by the vehicle and includes working assembly ground-engaging rotatable members that follow the ground independently of the vehicle ground-engaging rotatable members 112.

### Ground-Working Machine in Working Position

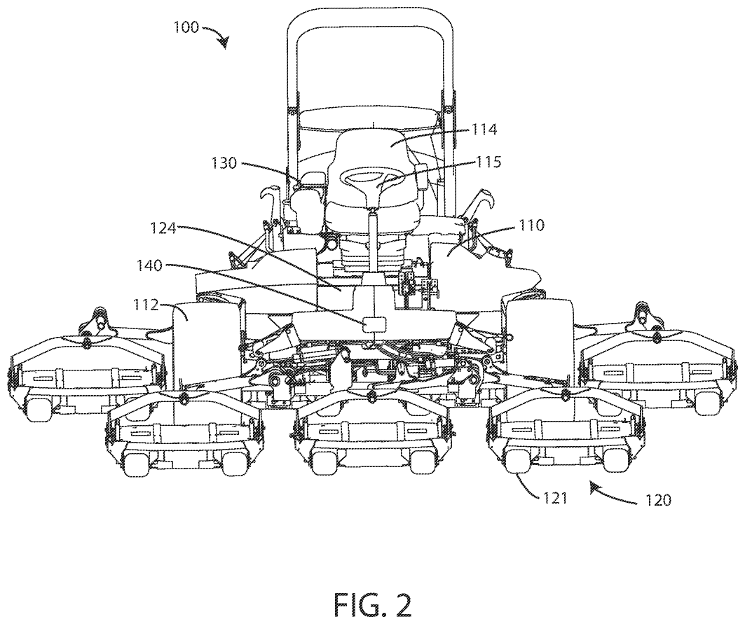

Referring now to FIG. 2, a front perspective view the ground-working machine of FIG. 1 is shown in accordance with various embodiments herein. In the example of FIG. 2, the plurality of working assemblies 120 are placed in a working position. A working position is defined herein as the position in which the working assembly ground-engaging rotatable members 121 are in contact with a ground surface. When in the working position, the working assemblies 120 are configured to be substantially parallel to the ground surface. When in the working position, the working assemblies 120 are individually self-supporting for movement over the ground through the working assembly ground-engaging rotatable members 121 carried on the front and rear of each working assembly 120. In various embodiments, the working assemblies 120 are provided with a floating motion in two degrees of freedom in the working position. In the working position, each working assembly 120 can pitch about a transverse pitch axis and can roll about a fore-and-aft roll axis.

### Ground-Working Machine in Raised Position

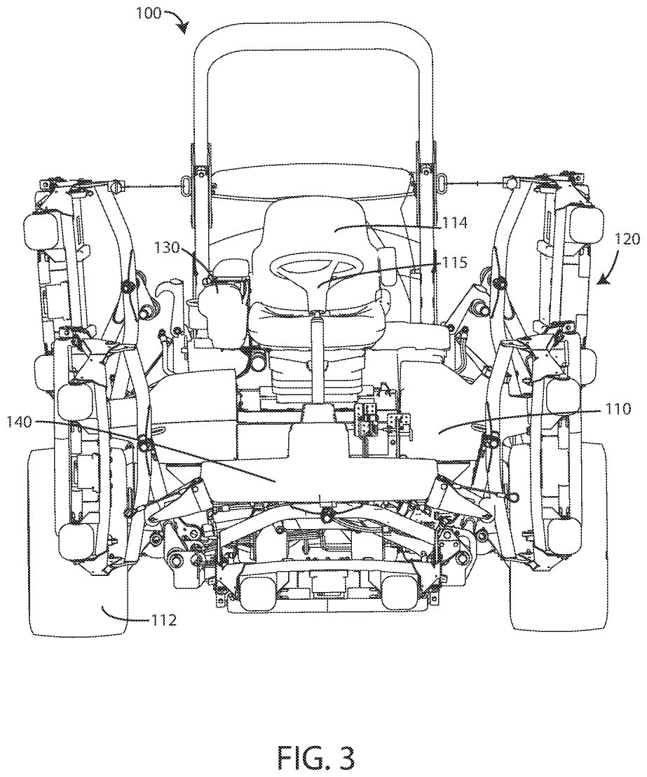

Referring now to FIG. 3, a front perspective view of ground-working machine is shown in accordance with various embodiments herein. In the example of FIG. 3, the plurality of working assemblies 120 are placed in a raised position. A raised position is defined herein as the position in which the working assembly ground-engaging rotatable members 121 are raised above the ground surface. In various embodiments, each connection assembly 122 is configured to move its respective working assembly 120 between the working position and the raised position.

In some embodiments, the user interface 130 can include a lift function configured to receive input from a user requesting movement of one or more of the working assemblies to a raised position. In some embodiments, all of the working assemblies 120 can be simultaneously moved between the working and raised positions. In some embodiments, each working assembly of the plurality of working assemblies can be individually moved between the working and raised positions.

As used herein, a height of a working assembly 120 is measured from the ground to a lowest part of the working assembly 120. In some embodiments, a height of the working assemblies 120 in the raised position can be greater than or equal to 0.05 meters, 0.25 meters. 0.5 meters, 0.7 meters. 0.7 meters, or 1.00 meters, or can be an amount falling within a range between any of the foregoing above the ground surface.

In various embodiments, the working assemblies 120 can form an angle with the ground surface when in the raised position. A plane of the ground surface can be defined by contact points of at least three vehicle ground-engaging rotatable members with the ground surface. A plane of a working assembly can be defined by points of the working assembly ground-engaging members that would first contact the ground surface when the working assembly is lowered down to the ground surface. As used herein, the angle formed between the working assembly and the ground surface is the acute angle formed by a line normal to the plane of the ground surface and a line normal to the plane of the working assembly. In some embodiments, the angle in the raised position between the ground-working assemblies and the ground can be greater than or equal to 0 degrees, 20 degrees, 40 degrees, 60 degrees, 80 degrees, 100 degrees, or 120 degrees, or can be an amount falling within a range between any of the foregoing.

In various embodiments, the ground-working machine 100 has a smaller overall width when the working assemblies in the raised position than when the working assemblies are in the working position. In various embodiments, the working assemblies are placed in the raised position for the purpose of transporting, shipping, or storing the ground-working machine 100 when the working assemblies are not mowing or otherwise performing their work. In some situations, one or more of the working assemblies can be in the raised position while one or more of the working assemblies can be in the working position.

### Longitudinal and Lateral Axes

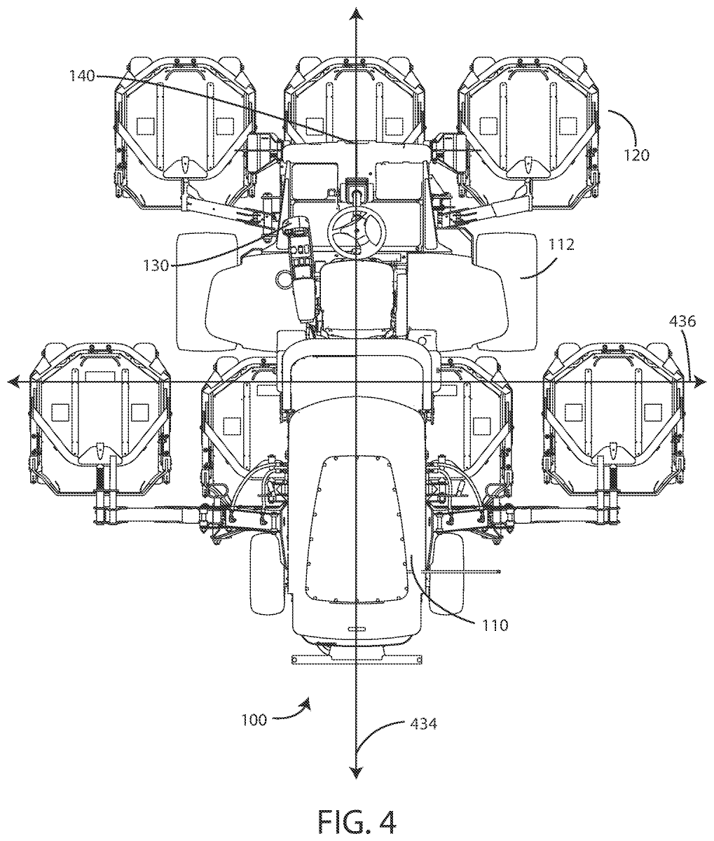

Referring now to FIG. 4, a top view of the ground-working machine of FIG. 1 is shown in accordance with various embodiments herein. The ground-working machine 100 can have longitudinal axis 434. In various embodiments, the longitudinal axis is located at a lateral center of the vehicle 110. In various embodiments, the working assemblies 120 are distributed symmetrically about longitudinal axis 434. In various embodiments, a first working assembly 120 of the plurality of working assemblies can be disposed to the left of a lateral center of the vehicle 110 and a second working assembly 120 of the plurality of working assemblies can disposed to the right of a lateral center of the vehicle 110. In the example of FIG. 4, three working assemblies 120 are distributed to the left of longitudinal axis 434, three working assemblies 120 are distributed to the right of longitudinal axis 434, and a single working assembly 120 is centered about longitudinal axis 434. In some embodiments, the working assemblies are not distributed symmetrically about longitudinal axis 434.

In various embodiments, the vehicle ground-engaging rotatable members 112 are distributed symmetrically about longitudinal axis 434. In the example of FIG. 4, two vehicle ground-engaging rotatable members 112 are distributed to the left of longitudinal axis 434 and two vehicle ground-engaging rotatable members 112 are distributed to the right of longitudinal axis 434.

The ground-working machine 100 can have a lateral axis 436. In various embodiments, lateral axis 436 is located at a longitudinal center of the vehicle 110. In various embodiments, the working assemblies 120 are distributed about lateral axis 436. In the example of FIG. 4, three working assemblies 120 are distributed in front of lateral axis 436 and four working assemblies 120 are distributed to mostly behind lateral axis 436. The front 140 of the vehicle 110 is in the direction that the operator seat 114 is facing and is in the direction of most typical forward travel from the operator seat 114.

In various embodiments, the vehicle ground-engaging rotatable members 112 are distributed about lateral axis 436. In the example of FIG. 4, two vehicle ground-engaging rotatable members 112 are distributed in front of the lateral axis 436 and two vehicle ground-engaging rotatable members 112 are distributed behind the lateral axis 436.

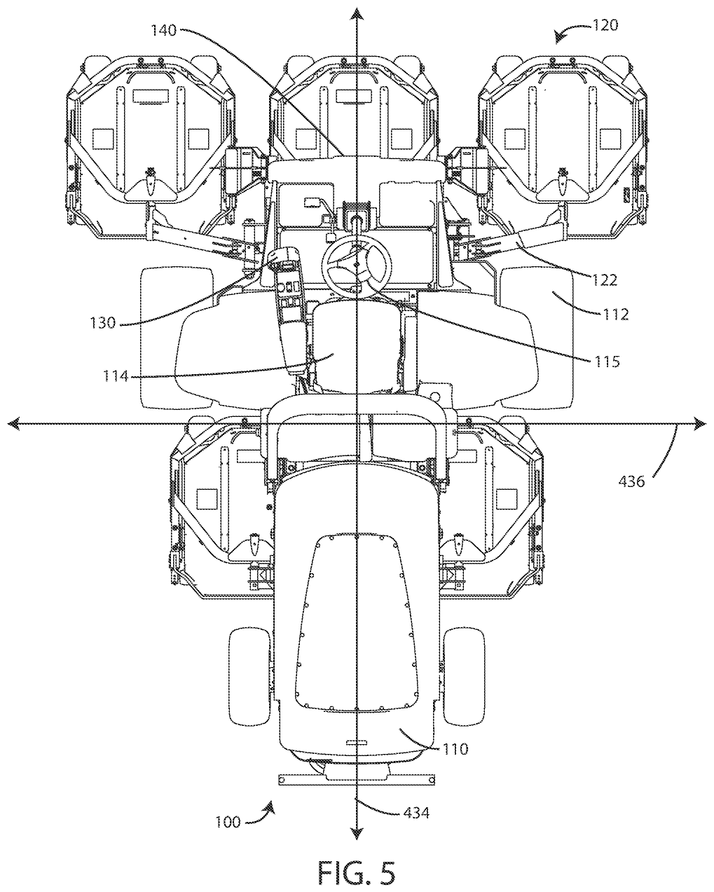

Referring now to FIG. 5, a top view of an alternative embodiment of a ground-working machine is shown in accordance with various embodiments herein. The ground-working machine 100 can have a vehicle having an operator seat 114 and operator controls, such as a steering wheel 115. The vehicle 110 may be operably connected by one or more connection assemblies 122 to a plurality of working assemblies 120. In the embodiment depicted by FIG. 5, the vehicle 110 has five working assemblies 120. The concepts and structures described here in for ground-working machine 100, vehicle 110 working assemblies 120 also apply to the ground-working machine 100, vehicle 110 working assemblies 120 of FIG. 5.

The ground-working machine 100 can have a longitudinal axis 434. In various embodiments, the longitudinal axis is located at a lateral center of the ground-working machine 100. In various embodiments, the working assemblies 120 are distributed symmetrically about longitudinal axis 434. In the example of FIG. 5, two working assemblies 120 are distributed to the left of longitudinal axis 434, two working assemblies 120 are distributed to the right of longitudinal axis 434, and a single working assembly 120 is centered about longitudinal axis 434.

In various embodiments, the vehicle ground-engaging rotatable members 112 are distributed symmetrically about longitudinal axis 434. In the example of FIG. 5, two vehicle ground-engaging rotatable members 112 are distributed to the left of longitudinal axis 434 and two vehicle ground-engaging rotatable members 112 are distributed to the right of longitudinal axis 434.

The ground-working machine 100 can have lateral axis 436 located at a longitudinal center of the vehicle 110. In various embodiments, the working assemblies 120 are distributed about lateral axis 436. In the example of FIG. 5, three working assemblies 120 are distributed in front of lateral axis 436 and two working assemblies 120 are distributed to the rear of lateral axis 436.

In various embodiments, the vehicle ground-engaging rotatable members 112 are distributed about lateral axis 436. In the example of FIG. 5, two vehicle ground-engaging rotatable members 112 are distributed in front of lateral axis 436 and two vehicle ground-engaging rotatable members 112 are distributed to the rear of lateral axis 436.

### Working Assembly

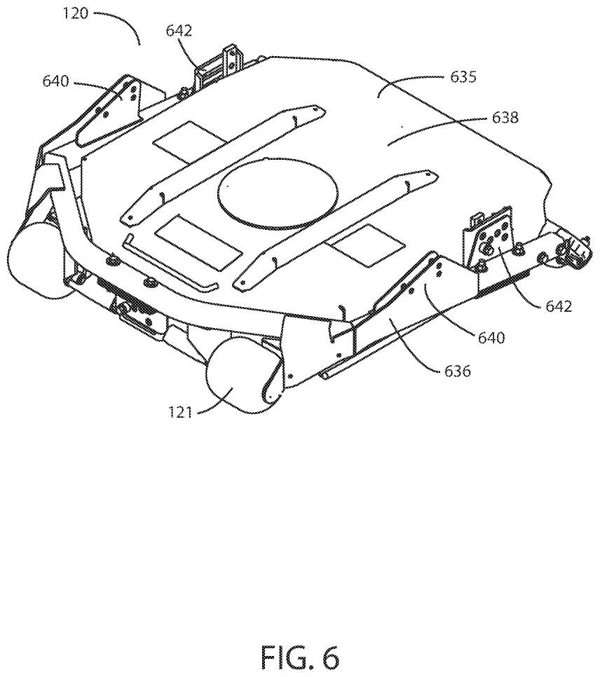

Referring now to FIG. 6, a perspective view of a working assembly is shown in accordance with various embodiments herein. As seen in FIG. 6, the working assembly 120 includes a carrier frame 636 with two or more ground-engaging rotatable members 121 connected to the carrier frame. In the embodiment of FIG. 6, the working assembly 120 has two front rotatable members and a rear rotatable member, such as two front wheels and an elongated rear roller. In another arrangement, the working assembly 120 can include four wheels or rollers, with one wheel or roller attached at each of the corners of the carrier frame or two elongated rollers. In another arrangement, the working assembly can include a front elongated roller and a rear elongated roller. Other numbers and configurations of working assembly ground-engaging rotatable members 121 are conceivable to those skilled in the art. In various embodiments, the carrier frame 636 can include a pair of brackets 640. The pair of brackets 640 can be disposed on opposite sides of the carrier frame 636 and configured to couple with a connection assembly, such as one of the connection assemblies 122 depicted by FIGS. 1-5.

The working assembly can have a ground-working unit 635 connected to the carrier frame 636. In the example of FIG. 6, the working unit 635 is configured as a rotary ground cutting assembly having a housing 638, a blade (not shown) that rotates around a substantially vertical axis within the housing 638. In alternative embodiments, the working assembly 120 can incorporate a reel cutting unit, a disc cutting unit, a flail cutting unit, or another type of cutting unit. In further embodiments, the working assembly 120 can be configured for spraying, debris collection, raking, or aerating, or the like.

A first bracket 640 attaches the connection assembly to a first side of the carrier frame 636 while a second bracket 640 attaches the connection assembly to a second, opposite side of the carrier frame 636. The working assembly 120 further includes brackets 642 that attach the carrier frame 636 to the housing 638 at opposite side of the housing 638. It is also possible for the brackets 642 to attach to a top surface of the housing 638, front portion of the housing 638, or both. The working assembly typically includes many structures that are not shown in FIG. 6. For example, in various embodiments, the working assembly includes a blade mounting and drive system in an aperture of the housing 638 of the working unit 635. In various embodiments, the working assembly may also include fluid power connections to the blade mounting and drive system and mechanisms for adjusting the height of the working unit.

### Connection Assemblies

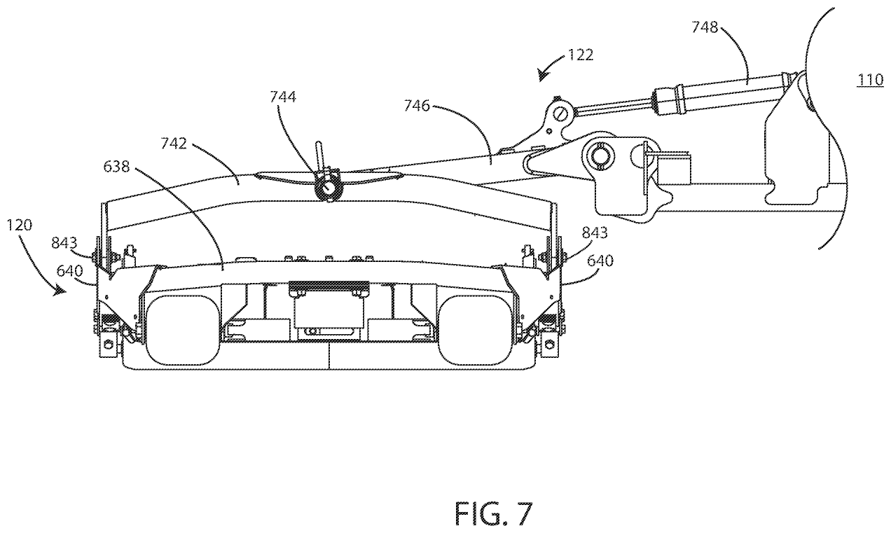

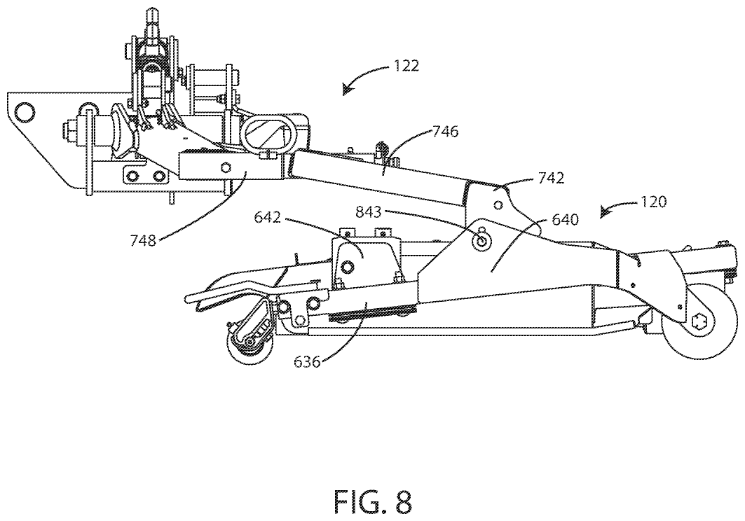

Referring now to FIGS. 7 and 8, a connection assembly is shown in accordance with various embodiments herein. The connection assembly 122 can include a connector handle 742, a connector arm 746, and a fluid power actuator 748. In various embodiments, the connection assembly 122 is configured to connect a working assembly 120 to the vehicle 110 of ground-working machine 100 such that the working assembly can be driven by the vehicle. In various embodiments, the connection assembly is configured to raise and lower the working assembly between a raised position and a working position and to apply a counterbalance pressure to the working assembly using the fluid power actuator 748. In various embodiments, the connection assembly 122 has a first end attached to a working assembly 120 and a second end attached to the vehicle 110.

In the embodiment of FIGS. 7 and 8, the working assembly 120 is attached to connector handle 742 at a pair of brackets 640 on carrier frame 636. In the example of FIGS. 7 and 8, each bracket 640 is located on a different side of the working assembly 120. The connector handle 742 spans a top surface of the working assembly 120 and each end of the connector handle 742 attaches to one of the brackets 640. As depicted by FIG. 8, the connector handle 742 is connected to each bracket 640 by a pivot joint 843. In various embodiments, the pivot joints 843 are configured to allow fore/aft rotation (rotation about an axis parallel to lateral axis 436) of the working assembly 120 with respect to the ground surface. Such rotation enables the working assemblies 120 to follow uneven terrain independently of vehicle 110 while being driven by the vehicle.

As depicted by FIG. 7, a center portion of the connector handle 742 can connect to a first end of a connector arm 746 at shaft connection 744. In various embodiments, shaft connection 744 is a pivot shaft configured to allow side-to-side rotation (rotation about an axis parallel to longitudinal axis 434) of the working assembly 120 with respect to the ground surface. Such rotation further enables the working assemblies 120 to follow uneven terrain independently of vehicle 110 while being driven by the vehicle.

In various embodiments, the connector arm 746 can connect to a linear actuator, such as fluid power actuator 748, and the vehicle 110 at a second end portion. In various embodiments, fluid power actuator 748 is configured to connect to the connector arm 746 at a first end and to the vehicle 110 at a second end. In the embodiment of FIGS. 7 and 8, the fluid power actuator 748 is configured as a hydraulic cylinder, but other fluid power actuators and other actuators are conceivable such as a pneumatic cylinders, screw type electric actuators, or the like. In addition, other types of linear actuators can be used in place of the fluid power actuator 748 in various embodiments, such as screw actuators or piezoelectric actuators.

In various embodiments, the fluid power actuator 748 connects to the connector arm 746 at a location in a portion near the second end but spaced away from the second end. The fluid power actuator 748 can be operatively connected to a hydraulic system 124 of the ground-working machine 100. In various embodiments, the hydraulic system 124 is configured to control the fluid power actuator 748. In some embodiments, the hydraulic system 124 can induce a retraction or extension of the fluid power actuator, resulting in a corresponding raising or lowering of the working assembly between the working position and the raised position via connector arm 746. In the embodiment of FIGS. 7-8, a retraction of the fluid power actuator 748 raises working assembly 120 and an extension of the fluid power actuator 748 lowers working assembly 120. In an alternate configuration, extension of the fluid power actuator 748 raises working assembly 120 and retraction of the fluid power actuator 748 lowers working assembly 120. In some embodiments, the hydraulic system can induce the fluid power actuator to offset at least part of the weight of the working assembly, transferring weight from the working assembly ground-engaging rotatable members 121 to the vehicle ground-engaging rotatable members 112. The hydraulic system is described in further detail below. In some embodiments, the hydraulic system can induce the fluid power actuator to place downward pressure on the working assembly, transferring weight from the vehicle ground-engaging rotatable members 112 to the working assembly ground-engaging rotatable members 121. The hydraulic system is described in further detail below.

### Hydraulic System

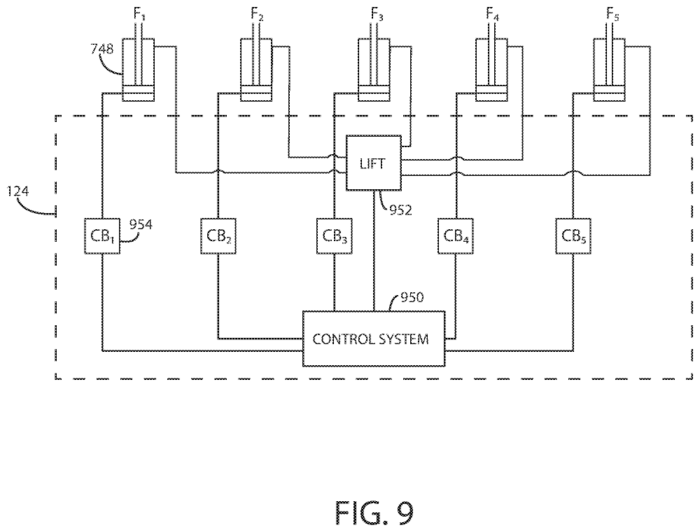

Referring now to FIG. 9, a schematic view of a hydraulic system for a ground-working machine is shown in accordance with various embodiments herein. It should be noted that the hydraulic system 124 depicted by FIG. 9 is simplified for explanatory purposes and the ground-working machine 100 can include additional hydraulic components such as valves, pumps, and the like. The hydraulic system 124 can include a control system 950, a lift valve 952, and a plurality of counterbalance valves 954. In various embodiments, the hydraulic system is configured to be disposed in the vehicle 110 of ground-working machine 100 such as in a lift block manifold within the vehicle.

The hydraulic system depicted by the example of FIG. 9 is configured for a ground-working machine 100 having five working assemblies 120. The exemplary hydraulic system has five counterbalance valves 954 (CB₁, CB₂ . . . CB₅) operatively connected to five fluid power actuators 748 (F₁, F₂ . . . F₅) where each fluid power actuator is operatively connected to a connection assembly 122 connecting a working assembly 120 to the vehicle 110. Similar configurations are possible for ground-working machines having different numbers of working units. For instance, a ground-working machine with seven working assemblies can have a hydraulic system with seven counterbalance valves (CB₁, CB₂ . . . CB₇) operatively connected to seven fluid power actuators (F₁, F₂ . . . F₇).

In various embodiments, hydraulic system 124 includes a lift valve 952 operatively connected to control system 950 and to the plurality of fluid power actuators 748. The lift valve 952 can be configured as a solenoid control valve or the like. In various embodiments, when a lift switch on the operator control panel is activated, the lift valve 952 is configured to apply a lift pressure to the working assemblies 120 to move the connection assembly to a raised position not contacting the ground surface.

When the ground-working machine 100 is in the working position (as depicted by FIG. 2) each working assembly 120 is substantially self-supporting on the ground and rolls over the ground on working assembly ground-engaging rotatable members 121. When the ground-working machine 100 is operating in the working position, the control system 950 is configured to control the lift valve 952 to permit hydraulic fluid to flow freely though the fluid power actuators 748 placing the fluid power actuators in a float mode. In doing so, the control system 950 permits the piston rod of each fluid power actuator 748 to move freely back and forth within each cylinder as the working assemblies 120 traverse the ground surface. This in turn allows each working assembly to follow the terrain of the ground.

To move the working assemblies 120 from the working position (depicted by FIG. 2) to the raised position (depicted by FIG. 3), when a lift switch on the operator control panel is activated, the control system 950 is configured to signal the lift valve 952 to open and for a pump (not shown) to supply pressurized hydraulic fluid to the plurality of fluid power actuators 748. In various embodiments, the hydraulic fluid pushes against the pistons of each of the fluid power actuators causing them to retract and lift their respective working assembly 120 to the raised position.

In turn, to lower the working assemblies 120 from the raised position back to the working position, when a switch on the operator control panel is activated, the control system 950 can signal the lift valve 952 to open and to control the pump to allow the hydraulic fluid to drain back out of the fluid power actuators 748 thereby permitting the working assemblies 120 to lower from their raised positions to their working positions. In some embodiments, the working assemblies 120 are lowered from their raised positions to their working positions by the force of gravity. Additionally or alternatively, the working assemblies 120 are lowered from their raised positions to their working positions using mechanical power, such as from the fluid power actuators 748.

In some embodiments, multiple lift valves are provided and are configured to raise and lower groups of working assemblies or single working assemblies. For example, one lift valve can be configured to raise and lower the five center working assemblies of FIG. 4, which includes the three working assemblies in front of the lateral axis 436 and the center two working assemblies that are mostly behind the lateral axis 436. A second lift valve can be configured to raise and lower the left, rear working assembly, and a third lift valve can be configured to raise and lower the right, rear working assembly.

In various embodiments, the hydraulic system can include a plurality of counterbalance valves 954. Each counterbalance valve 954 can include one or more hydraulic valves. Each counterbalance valve 954 can be operatively connected to control system 950 and to a fluid power actuator 748 of the plurality of fluid power actuators (F₁, F₂ . . . F₅). Each counterbalance valve 954 can be configured as a solenoid control valve, or the like. In various embodiments, each counterbalance valve 954 is configured to apply a counterbalance pressure or back pressure to its respective working assembly 120 via the fluid power actuator 748. The counterbalance pressure causes a lift force to be applied to each working assembly 120, transferring at least a portion of the weight of the working assembly to the vehicle 110 while the working assembly ground-engaging rotatable members 121 remain in contact with the ground surface.

The counterbalance pressure applied by each counterbalance valve 954 can be a function of a counterbalance value determined by control system 950. In various embodiments, each counterbalance valve 954 is configured to apply a counterbalance pressure dynamically to its respective working assembly based on one or more inputs received from control system 950. Each counterbalance valve 954 can be operatively connected to a connection assembly 122 and each connection assembly can apply a counterbalance pressure of the determined counterbalance value to its respective working assembly 120.

In various embodiments, the counterbalance valves 954 apply the counterbalance pressure while the ground-working machine 100 is in the working position. When in the working position without a counterbalance pressure applied, the working assembly ground-engaging rotatable members 121 transfer most of their weight directly to the ground. In some cases, this can adversely affect the traction of the vehicle 110. Accordingly, there are times when it would be desirable to transfer at least a portion of the weight of the working assemblies 120 back to the vehicle to put more downforce on the vehicle ground-engaging rotatable members 112 thereby increasing their traction. To accomplish this, each connection assembly 122 is configured to apply a counterbalance pressure to its respective working assembly 120. The counterbalance pressure applies an upward force to each working assembly 120 and shifts weight from the working assembly ground-engaging rotatable members 121 to the vehicle ground-engaging rotatable members 112. The amount of counterbalance pressure applied to each working assembly is determined by the counterbalance system using inputs which is described in detail below.

### Counterbalance System

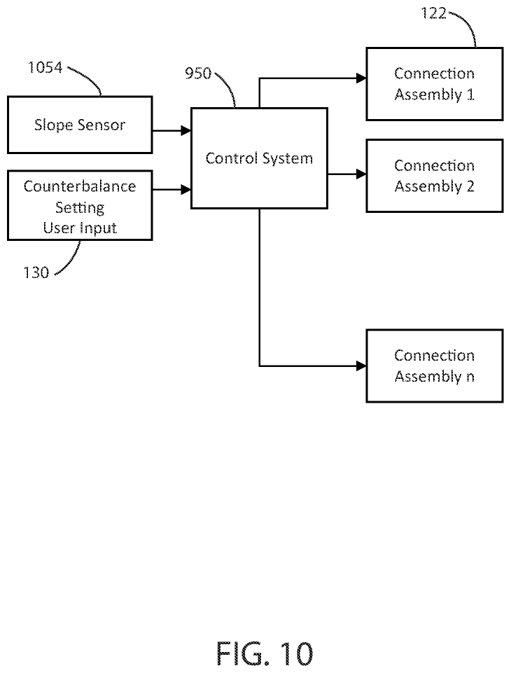

Referring now to FIG. 10, a schematic view of a counterbalance system is shown in accordance with various embodiments herein. In various embodiments, the counterbalance system includes control system 950. The control system can be configured to receive one or more inputs and, based on the one or more inputs, determine an appropriate counterbalance pressure for each working assembly 120, and dynamically apply a counterbalance pressure or change an already-applied counterbalance pressure to each of the working assemblies 120 via its respective connection assembly 122. The inputs to the control system 950 will now be described.

### Slope Sensor

In various embodiments, the control system 950 is configured to receive an input from a slope sensor 1054. A slope sensor defined herein is an instrument used for measuring angles of slope, elevation, or depression of an object with respect to gravity's direction. The slope sensor 1054 can take the form of an accelerometer, a liquid capacitive inclinometer, electrolytic tilt sensor, gas bubble in liquid sensor, pendulum, or the like. In some embodiments the slope sensor 1054 be configured to measure the slope along one, two, three, or four or more axes.

In various embodiments, the slope sensed by the slope sensor 1054 can be reflective of the attitude of the ground-working machine 100 with respect to a ground surface. In various embodiments, the slope sensor 1054 can be disposed on or within the vehicle 110 of the ground-working machine 100 to determine the attitude of vehicle 110 relative to a substantially horizontally reference plane.

In various embodiments, the control system 950 receives one or more slope values from the slope sensor 1054. Each slope value can indicate a slope of the vehicle 110 with respect to a horizontal reference plane. In various embodiments, the control system 950 is configured to receive a lateral slope value from the slope sensor 1054. The lateral slope value can indicate a slope of the vehicle 110 along lateral axis 436 with respect to a horizontal reference plane. In various embodiments, the control system 950 is configured to receive a longitudinal slope value from the slope sensor 1054. The longitudinal slope value can indicate a slope of the vehicle 110 along longitudinal axis 434 with respect to a horizontal reference plane. In an exemplary embodiment, the control system 950 is configured to receive a both longitudinal slope value and a lateral slope value from the slope sensor 1054. It should be noted that the control system 950 can be configured to receive any number of slope values along any number of axes from the slope sensor. In some embodiments, the number of slope values received by the control system 950 can be greater than or equal to one, two, three, or four or more slope values. In most instances where the description references the input of a slope value, the system could also have two or more slope values as inputs.

In various embodiments, based on the slope value or slope values received from the slope sensor 1054, the control system 950 is configured to determine whether to apply a counterbalance pressure or change an already-applied counterbalance pressure to each of the working assemblies 120 via its connection assembly 122. If a determination is made to apply or change a counterbalance pressure at a particular working assembly 120, the control system 950 is configured to determine a counterbalance value based on the slope value or slope values and a location of the particular working assembly with respect to the vehicle. The control system 950 is configured to apply a counterbalance pressure of the determined counterbalance value via a connection assembly 122 to each particular working assembly 120 for which a determination was made to apply or change a counterbalance pressure. In various embodiments, the working assembly ground-engaging rotatable members 121 of each working assembly remain in contact with a ground surface while the determined counterbalance pressure is applied.

In various embodiments, higher counterbalance values will be output by the control system 950 to the fluid power actuators 748 of the working assemblies on an uphill side of the vehicle 110, per data from the slope sensor 1054. For instance, upon reading a slope value that is at or above a threshold, the control system 950 is configured to set a larger uphill counterbalance value for an uphill one of the working assemblies 120 disposed above the vehicle 110 on the slope and set a smaller downhill counterbalance pressure for a working assembly 120 disposed below the vehicle 110 on the slope.

In various embodiments, the counterbalance pressure applied to each working assembly 120 changes dynamically as a function of one or more factors including the slope value. The control system is configured to read the slope value from the slope sensor 1054 and adaptively output counterbalance values continuously or at a set time interval. In some embodiments, the set time interval can be greater than or equal to 0.01, 0.02, 0.02, 0.03, or 0.04 seconds. In some embodiments, the set time interval can be less than or equal to 0.10, 0.08, 0.07, 0.06, or 0.04 seconds. In some embodiments, the set time interval can fall within a range of 0.01 to 0.10 seconds, or 0.02 to 0.08 seconds, or 0.02 to 0.07 seconds, or 0.03 to 0.06 seconds, or can be about 0.04 seconds.

In alternative embodiments, the control system can take a rolling average of values from the slope sensor as an input to the counterbalance algorithm. In some embodiments, the rolling average can be taken over greater than or equal to two, three, four, or five slope values. In some embodiments, the rolling average can be taken over less than or equal to ten, eight, seven, or five slope values. In some embodiments, the rolling average can be taken over a range of two to ten slope values, or three to eight slope values, or four to seven slope values, or can be about five slope values.

In various embodiments, the counterbalance pressure applied to a given working assembly 120 changes dynamically with the slope. In various embodiments, when the slope is below a threshold value, the counterbalance pressure set for the working assembly will be a baseline counterbalance pressure. In some embodiments, the baseline counterbalance can be zero. Alternatively, the baseline counterbalance pressure can be above zero. In some embodiments, the threshold slope can be zero. Alternatively, the threshold slope can be above zero. In some embodiments, the threshold slope angle can be greater than or equal to zero, one, or two degrees with respect to a horizontal reference plane. In some embodiments, the threshold slope angle can be less than or equal to ten, six, or two degrees with respect to a horizontal reference plane. In some embodiments, the threshold slope angle can fall within a range of zero to ten degrees with respect to a horizontal reference plane, or one to six degrees with respect to a horizontal reference plane or can be about two degrees with respect to a horizontal reference plane.

The change in slope is a dynamic input to which the control system responds. For instance, the counterbalance pressure applied to a working assembly 120 disposed uphill from the vehicle 110 on a slope increases as the slope steepens until the maximum allowable counterbalance pressure has been achieved. Once the maximum allowable counterbalance value for a particular working assembly has been reached, steeper slope values will not further increase the counterbalance value. In some embodiments, the maximum allowable counterbalance pressure corresponds to the counterbalance pressure at which the weight of the working assembly 120 has substantially all be transferred to the vehicle 110, but the working assembly ground-engaging rotatable members 121 remain engaged with the ground surface.

In the examples described herein, a forward uphill is defined as a positive slope value while a rearward uphill is defined as a negative slope value. In the examples described herein, a rightward uphill is defined as a positive slope value while a leftward uphill is defined as a negative slope value. In alternative examples, these are reversed or the slope sensor output uses a different type of scale with all positive values or all negative values.

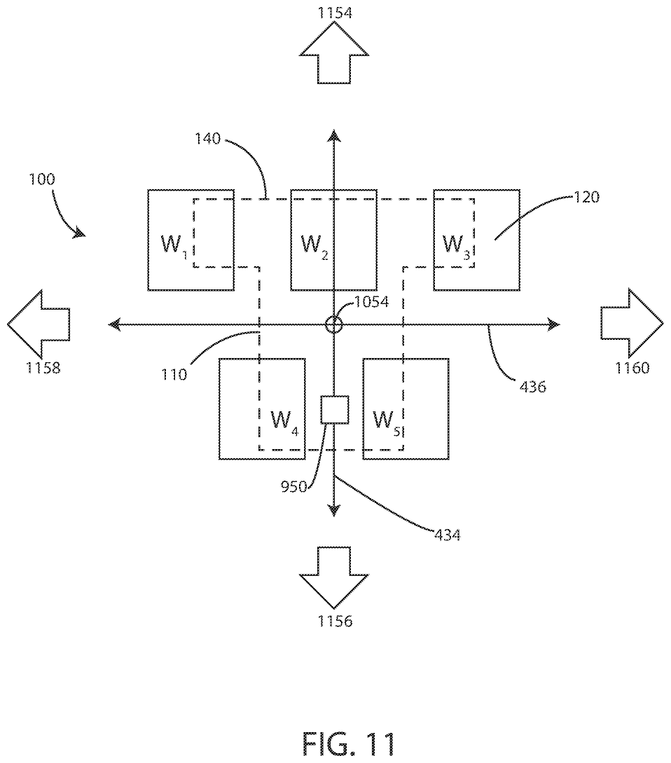

### Counterbalance Operations Based on Slope Input Scenarios (FIG. 11)

Referring now to FIG. 11, a schematic view of a ground-working machine on a ground surface is shown in accordance with various embodiments herein. The ground-working machine 100 can have some of or all the features of the ground-working machines described previously but is drawn schematically for clarity. The ground-working machine 100 includes a vehicle 110 and five working assemblies 120 (labeled W₁ . . . W₅). The ground-working machine can be defined by longitudinal axis 434 and lateral axis 436. As illustrated in other FIGS., but not in FIG. 11, each working assembly 120 can have a working unit 635 and a plurality of working assembly ground-engaging rotatable members 121 configured to contact the ground surface. Each working assembly 120 can be attached to the vehicle with a connection assembly (not shown in FIG. 11). FIG. 11 shows a ground-working machine with five working assemblies in a three-two configuration, meaning that three in a front row of working assemblies and two are in a rear row of working assemblies. Although the present example describes a ground-working machine with five working assemblies in a three-two configuration, the principles described herein apply to ground-working machines having other numbers of working assemblies or other configurations of working assemblies. For example, FIGS. 1-4 show a ground-working machine with seven working assemblies in a three-four configuration, with three in a front row and four in a rear row. Another possible configuration is a ground-working machine with three working assemblies in a one-two configuration with one in a front row and two in a rear row.

The ground-working machine 100 can further include a slope sensor 1054 and a control system 950 disposed on or within the vehicle 110. In some embodiments, the slope sensor 1054 is located along the longitudinal axis 434. In some embodiments, the slope sensor 1054 is located at the intersection of the lateral axis and longitudinal axis shown in FIG. 4. In some embodiments, the slope sensor 1054 is located under the operator seat 114. It should be noted that the slope sensor can be located on any rigid portion of the vehicle 110 such as the frame, the rollover protection structure, or the like. In various examples, the control system 950 is configured to receive a longitudinal slope value, a lateral slope value, or both from the slope sensor 1054. As previously described, the longitudinal slope value indicates a slope of the vehicle 110 along longitudinal axis 434 with respect to a horizontal reference plane and lateral slope value indicates a slope of the vehicle 110 along lateral axis 436 with respect to the direction of gravity.

The impact of different ground conditions and corresponding slope inputs on various embodiments of the counterbalance system will now be described. The schematic of FIG. 11 will be referenced to describe how examples of the counterbalance system can respond to five different ground slope conditions: substantially flat, a forward uphill slope 1154, a rearward uphill slope 1156, a leftward uphill slope 1158, and a rightward uphill slope 1160.

### Substantially Flat

When the ground surface is relatively flat, the slope sensor will detect zero longitudinal slope and zero lateral slope. The slope sensor 1054 will then output a longitudinal slope value of zero and a lateral slope value of zero to the control system. Based on the input from the slope sensor, the control system 950 assigns the same counterbalance value for all of the working assemblies 120 (labeled W₁ . . . W₅). This counterbalance value will be referred to as the baseline counterbalance value herein. The magnitude of the baseline counterbalance value can be determined by a number of additional inputs to the control system, which will be described in detail below. Irrespective of the additional inputs, the baseline counterbalance value will be the same for all five working assemblies. Each connection assembly 122 will then apply a substantially equal counterbalance pressure to its respective working assembly 120.

### Forward Uphill and Rearward Uphill

If the vehicle is on a ground surface with a forward uphill slope 1154 and no lateral slope, the slope sensor 1054 will detect a positive longitudinal slope and zero lateral slope. The slope sensor 1054 will then output a positive longitudinal slope value and a lateral slope value of zero to the control system 950. In one embodiment, based on the input from the slope sensor, the control system assigns an equal counterbalance value to each of the working assemblies (W₁ . . . W₅). Without being bound to a particular theory, when ground-working machine 100 encounters a purely longitudinal slope, its performance tends to be limited by the traction of the vehicle ground-engaging rotatable members 121 (i.e., the ground-engaging rotatable members start to slip) rather than stability of the vehicle ground-engaging rotatable members (i.e., the ground-engaging rotatable members losing contact with the ground surface). For this reason, in this embodiment, the counterbalance algorithm shifts the weight of the working assemblies 120 to the vehicle 110 to maximize the traction of the vehicle ground-engaging rotatable members 112. Accordingly, as the steepness of forward uphill slope 1154 increases, the counterbalance pressure applied to all the working assemblies (W₁ . . . W₅) will remain equal and continue to increase until a maximum counterbalance value is reached.

If the vehicle is on a ground surface with a rearward uphill slope 1156 and no lateral slope, the slope sensor 1054 will detect a negative longitudinal slope and zero lateral slope. The slope sensor 1054 will then output a negative longitudinal slope value and a lateral slope value of zero to the control system 950. Based on the input from the slope sensor, the control system assigns an equal counterbalance value to each of the working assemblies (W₁ . . . W₅), as discussed above with respect to a frontward uphill slope. As the steepness of rearward uphill slope 1156 increases, the counterbalance pressure applied to all of the working assemblies (W₁ . . . W₅) will remain equal and continue to increase until a maximum counterbalance value is reached.

In an alternative embodiment, the system will respond differently to a positive longitudinal slope compared to a negative longitudinal slope. Upon detecting a positive longitudinal slope and zero lateral slope with the slope sensor, the control system assigns a counterbalance value that is higher than the baseline counterbalance value to the frontward working assemblies (W₁, W₂, W₃) and a counterbalance value that is lower than the baseline counterbalance value to the rearward working assemblies (W₄, W₅). In turn, the connection assemblies connected to the frontward working assemblies (W₁, W₂, W₃) will apply higher counterbalance pressure to their respective working assemblies than the connection assemblies connected to rearward working assemblies (W₄, W₅). As the steepness of forward uphill slope 1154 increases, the counterbalance pressure applied to frontward working assemblies (W₁, W₂, W₃) will continue to increase until a maximum counterbalance value is reached, and the counterbalance pressure applied to rearward working assemblies (W₄, W₅) will continue to decrease until a minimum counterbalance value is reached.

In this alternative embodiment, upon detecting a negative longitudinal slope and zero lateral slope with the slope sensor, the control system assigns a counterbalance value that is lower than the baseline counterbalance value to the frontward working assemblies (W₁, W₂, W₃) and a counterbalance value that is higher than the baseline counterbalance value to the rearward working assemblies (W₄, W₅). In turn, the connection assemblies connected to the frontward working assemblies (W₁, W₂, W₃) will apply lower counterbalance pressure to their respective working assemblies than the connection assemblies connected to rearward working assemblies (W₄, W₅). As the steepness of rearward uphill slope 1156 increases, the counterbalance pressure applied to rearward working assemblies (W₄, W₅) will continue to increase until a maximum counterbalance value is reached and the counterbalance pressure applied to frontward working assemblies (W₁, W₂, W₃) will continue to decrease until a minimum counterbalance value is reached.

### Leftward Uphill

If the vehicle is on a ground surface with a leftward uphill slope 1158 and no longitudinal slope, the slope sensor 1054 will detect zero longitudinal slope and a negative lateral slope. The slope sensor 1054 will then output a longitudinal slope value of zero and a negative lateral slope value to the control system 950. Based on the input from the slope sensor, the control system assigns a counterbalance value that is higher than the baseline counterbalance value to the leftward working assemblies (W₁, W₄), a counterbalance value that is lower than the baseline counterbalance value to the rightward working assemblies (W₃, W₅) and a counterbalance value that is equal to the baseline counterbalance value to the center working assembly (W₂). In turn, the connection assemblies connected to the leftward working assemblies (W₁, W₄) will apply higher counterbalance pressure to their respective working assemblies than the connection assemblies connected to rearward rightward working assemblies (W₃, W₅) and the connection assembly connected to the center working assemblies (W₂) will apply a counterbalance pressure that is in between the pressure applied to leftward and rightward working assemblies. As the steepness of leftward uphill slope 1158 increases, the counterbalance pressure applied to leftward working assemblies (W₁, W₄) will continue to increase until a maximum counterbalance value is reached, the counterbalance pressure applied to rightward working assemblies (W₃, W₅) will continue to decrease until a minimum counterbalance value is reached, and the counterbalance pressure applied to center working assembly (W₂) will remain constant.

### Rightward Uphill

If the vehicle is on a surface with a rightward uphill slope 1160 and no longitudinal slope, the slope sensor 1054 will detect zero longitudinal slope and a positive lateral slope. The slope sensor 1054 will then output a longitudinal slope value of zero and a positive lateral slope value to the control system 950. Based on the input from the slope sensor, the control system assigns a counterbalance value that is lower than the baseline counterbalance value to the leftward working assemblies (W₁, W₄), a counterbalance value that is higher than the baseline counterbalance value to the rightward working assemblies (W₃, W₅), and a counterbalance value that is equal to the baseline counterbalance value to the center working assembly (W₂). In turn, the connection assemblies connected to the leftward working assemblies (W₁, W₄) will apply a lower counterbalance pressure to their respective working assemblies than the connection assemblies connected to rightward working assemblies (W₃, W₅) and the connection assembly connected to the center working assemblies (W₂) will apply a counterbalance pressure that is in between the pressure applied to leftward and rightward working assemblies. As the steepness of rightward uphill slope 1160 increases, the counterbalance pressure applied to leftward working assemblies (W₁, W₄) will continue to decrease until a minimum counterbalance value is reached, the counterbalance pressure applied to rightward working assemblies (W₃, W₅) will continue to increase until a minimum counterbalance value is reached, and the counterbalance pressure applied to center working assembly (W₂) will remain constant.

### Simultaneous Longitudinal and Lateral Slope

The same reasoning applies to ground surfaces having non-zero values for both longitudinal and lateral slope values. For instance, if the vehicle 110 were placed on a ground surface having both a leftward and a frontward uphill, the control system 950 would set the counterbalance pressure applied to working assembly W₁ to be the highest of all of the working assemblies and the counterbalance pressure applied to working assembly W₅ be the lowest of all the working assemblies.

### Counterbalance Setting User Input

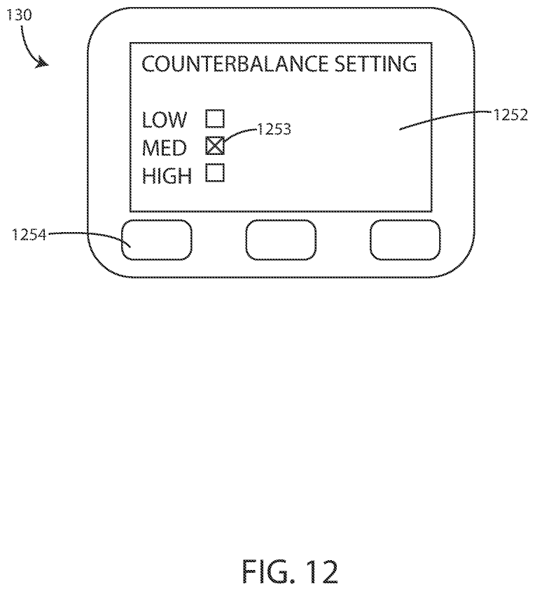

Referring now to FIG. 12, a schematic view of a user interface is shown in accordance with various embodiments herein. The user interface 130 can include a display 1252. The display can be configured to show a plurality of counterbalance settings 1253. The user interface 130 can include a user input device 1254, such as a button for changing or accepting a counterbalance setting. The user input is configured to enable a user to select a counterbalance setting of the plurality of counterbalance settings 1253. Many other user input devices are possible, such as a dial, a touchscreen, or a switch.

Referring to FIG. 10, the control system 950 can be configured to receive a first input from a slope sensor 1054 and a second input, a counterbalance setting user input, from user interface 130. In various embodiments the control system 950 can be configured to output a range of counterbalance values spanning a dynamic counterbalance range. The dynamic counterbalance range can be bounded by a minimum counterbalance value (at which the lowest possible counterbalance pressure is applied to a working assembly) and a maximum counterbalance pressure (at which the highest possible counterbalance pressure is applied to a working assembly). In one example, the minimum counterbalance value can be zero, corresponding to zero counterbalance pressure being applied to the working assemblies 120. Alternatively, the minimum counterbalance pressure can be above zero, corresponding to a non-zero counterbalance pressure being applied to the working assemblies 120. In some embodiments, the maximum counterbalance value corresponds to a counterbalance pressure that generates an upward force of the working assembly 120 that is less than the force required to lift a working assembly from the ground. In an embodiment, the maximum counterbalance value corresponds to a counterbalance pressure that generates an upward force on the working assembly 120 that transfers substantially all of the weight of the working assembly to the vehicle 110 but is below the force required to lift the working assembly from the ground surface.

In various embodiments, the control system is configured to receive a counterbalance setting 1253 from a user via the user interface 130. The counterbalance setting 1253 can determine the dynamic counterbalance range. The dynamic counterbalance range is defined by a minimum counterbalance value and a maximum counterbalance value. In some embodiments, the minimum counterbalance value is determined by the counterbalance setting 1253. In various embodiments, the user interface can include a plurality of counterbalance settings 1253. Each counterbalance setting is input to define the dynamic counterbalance range. In some embodiments, the counterbalance setting is selected from a low counterbalance setting and a high counterbalance setting. The low counterbalance setting can cause a lower minimum counterbalance value to be used than the high counterbalance setting. In various embodiments, the counterbalance setting sets the minimum counterbalance value and the counterbalance values outputted by the control system can fluctuate between the minimum and maximum counterbalance values based on inputs received by the control system 950, including at least the slope value(s) received from the slope sensor 1054.

In the exemplary embodiment of FIG. 12, the user interface 130 includes three counterbalance settings 1253. For the purposes of a first example, it will be assumed that the minimum possible counterbalance value for a ground-working machine is zero and the maximum possible counterbalance value is ten. In one example, at a counterbalance value of ten, the upward force of the working assembly 120 that is just slightly less than the force required to lift a working assembly from the ground and can be calibrated during the manufacturing process. In some embodiments, the settings can be denoted LOW, MED and HIGH. In this example, the LOW counterbalance setting can have minimum counterbalance value of 3 and a maximum counterbalance of 10, the MED counterbalance setting can have minimum counterbalance value of 5 and a maximum counterbalance of 10, the HIGH counterbalance setting can have minimum counterbalance value of 7 and a maximum counterbalance of 10. If the user were to select the MED counterbalance setting, as depicted by FIG. 12, the dynamic counterbalance range would be 5-10. As the ground-working machine 100 traverses the ground surface, the counterbalance value set by the control system 950 for each working assembly 120 can fluctuate between 5 and 10 depending on a number of factors including at least the slope of the ground surface.

In a second example consistent with FIG. 12, for all possible counterbalance settings, the minimum counterbalance value is above zero and the maximum counterbalance value is the maximum possible counterbalance value for the ground-working machine. However, in some embodiments, the user interface 130 can include one or more counterbalance settings with a minimum counterbalance value of zero and/or a maximum counterbalance value below the maximum possible counterbalance value. It should further be noted that the user interface can include any number of counterbalance settings. In some embodiments, the number of counterbalance settings can be greater than or equal to two, three, four, or five settings, or can be an amount falling within a range between any of the foregoing.

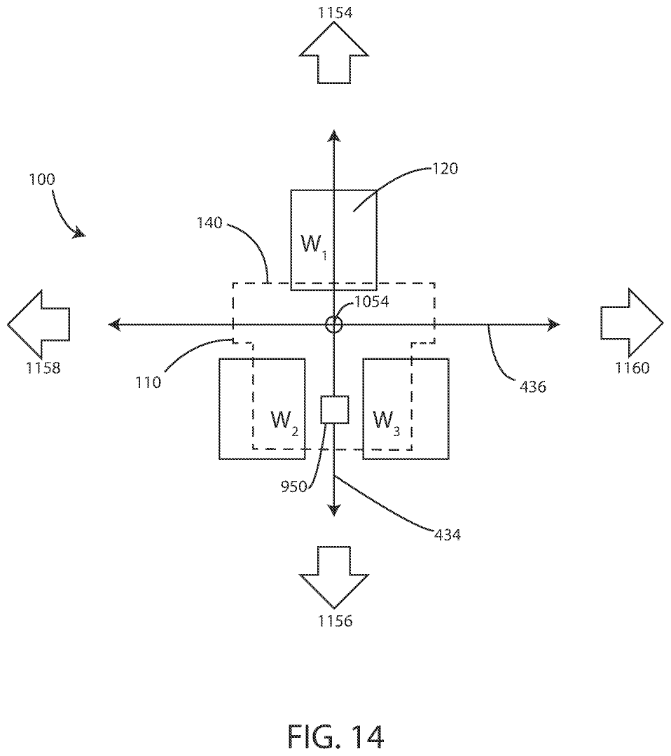

### Counterbalance System Example for a One-Two Configuration (FIG. 14)

Referring now to FIG. 14 a schematic diagram of a counterbalance system example for a ground-working machine is shown in accordance with various embodiments herein. The ground-working machine 100 can have some of or all the features of the ground-working machines described previously but is drawn schematically for clarity. The ground-working machine 100 includes a vehicle 110 and three working assemblies 120 (labeled W₁, W₂, W₃). The ground-working machine can be defined by longitudinal axis 434 and lateral axis 436. As illustrated in other FIGS., but not in FIG. 14, each working assembly 120 can have a working unit 635 and a plurality of working assembly ground-engaging rotatable members 121 configured to contact the ground surface. Each working assembly 120 can be attached to the vehicle with a connection assembly (not shown in FIG. 14). FIG. 14 shows a ground-working machine with three working assemblies in a one-two configuration, meaning that one working assembly (W₁) is in a front row of working assemblies and two working assemblies are in a rear row of working assemblies (W₂ and W₃). In an exemplary embodiment, the counterbalance applied to each of the three working assemblies can be set by the following equations:

$${CB}_{1} = min ( {CB}_{User Input} + \vert \frac{Longitudinal Slope}{Longitudinal Slope Limit} \vert * ( {CB}_{Absolute Max} - {CB}_{min ( user input )} ) , 1 )$$

$${CB}_{2} = IF ( min ( ( {CB}_{1} - \vert \frac{Lateral Slope}{Lateral Slope Limit} \vert ) , 1 ) > 0 , \\ min ( ( {CB}_{1} - \vert \frac{Lateral Slope}{Lateral Slope Limit} \vert ) , 1 ) , 0 )$$

$${CB}_{3} = IF ( min ( ( {CB}_{1} + \vert \frac{Lateral Slope}{Lateral Slope Limit} \vert ) , 1 ) > 0 , \\ min ( ( {CB}_{1} + \vert \frac{Lateral Slope}{Lateral Slope Limit} \vert ) , 1 ) , 0 )$$

In this example, CB₁ is the counterbalance applied to the working assembly W₁ at the front of the ground-working machine, CB₂ is the counterbalance applied to the working assembly W₂ to the left of longitudinal axis 434, and CB₃ is the counterbalance applied to the working assembly W₃ to the right of longitudinal axis 434. The min(x, y) function operates to identify the smallest value of the values listed. Each of the parameters for the preceding equations will be described in detail below.

Table 1 summarizes constant inputs of one embodiment of a counterbalance algorithm for the ground-working machine of FIG. 14. These constant inputs are established in the algorithm and are not modified by sensor inputs or user input. These constant inputs can be modified, however, by an administrator with the permission to modify the algorithm, to optimize the algorithm for a set of working conditions.

TABLE 1

| | Example |
|---|---|
| Constants | Value |
| CB Absolute Min | 0% |
| CB Absolute Max | 100% |
| Min (User LOW) | 10% |
| Min (User MED) | 30% |
| Min (User HIGH) | 60% |
| Longitudinal Slope Limit (Degrees) | 30 |
| Lateral Slope Limit (Degrees) | 15 |

In various embodiments, the counterbalance algorithm can include parameters for an absolute maximum counterbalance pressure (“CB Absolute Max”) and an absolute minimum counterbalance pressure (“CB Absolute Min”). The constant “CB Absolute Min” as defined herein is the absolute minimum counterbalance pressure that can be applied to each working assembly 120. In various embodiments the absolute minimum counterbalance pressure is 0%, meaning that none of the weight of the working assemblies is transferred to the vehicle. The constant “CB Absolute Max” is defined herein as the absolute maximum counterbalance pressure that can be applied to each of the working assemblies 120. In various embodiments the absolute maximum counterbalance pressure is 100%, meaning that substantially all the weight of the working assemblies 120 is transferred to the vehicle 110. In an embodiment, the maximum counterbalance value of 100% corresponds to a counterbalance pressure that generates an upward force on the working assembly 120 that transfers substantially all the weight of the working assembly to the vehicle 110 but is below the force required to lift the working assembly from the ground surface.

The algorithm further includes constants defining the minimum counterbalance pressure based on a user input. As described above, the ground-working machine includes a user input that enables a user to select a counterbalance setting of the plurality of counterbalance settings. The counterbalance setting determines the minimum counterbalance pressure that can be applied to the working assemblies. The constant “Min (User LOW)” is the lowest counterbalance pressure that can be applied to the working assemblies at a low counterbalance setting. In some embodiments, the constant “Min (User LOW)” is equal to the minimum counterbalance value “CB Absolute Min”. In some embodiments, the constant “Min (User LOW)” is greater than the minimum counterbalance value “CB Absolute Min”. The constant “Min (User MED)” is the lowest counterbalance pressure that can be applied to the working assemblies at a medium counterbalance setting. The constant “Min (User HIGH)” is the lowest counterbalance pressure that can be applied to the working assemblies at a high counterbalance setting. In some embodiments, the constant “Min (User HIGH)” is equal to the maximum counterbalance value “CB Absolute Max”. In some embodiments, the constant “Min (User HIGH)” is less than the maximum counterbalance value “CB Absolute Max”. As seen in Table 1, in one example, the values for “Min (User LOW)”, “Min (User MED)”, and “Min (User HIGH)” are 10%, 30% and 60%, respectively.

In some embodiments, the counterbalance pressures applied to each working assembly 120 will plateau at a predefined slope limit. At slopes above these limits, the counterbalance pressures applied to each working machine will remain constant. The constant “Longitudinal Slope Limit” is the longitudinal slope at which the applied counterbalance pressure will plateau. The constant “Lateral Slope Limit” is the lateral slope at which the applied counterbalance pressure will plateau. In some embodiments, the ground-working machine will issue a warning or cease to operate if the slope exceeds the longitudinal and/or lateral slope limits as operating a ground-working machine on a steep slope can be hazardous. As seem in Table 1, in one example, the values for “Longitudinal Slope Limit” and “Lateral Slope Limit” are 30 degrees and 15 degrees, respectively.

TABLE 2

| User/Environmental Inputs | Example Value |
|---|---|
| CB User Input | MED |
| Longitudinal Slope (Degrees) | 10 |
| Lateral Slope (Degrees) | 10 |

Table 2 summarizes the user and environmental inputs that go into the example counterbalance algorithm. The parameter “CB User Input” is the counterbalance setting input by the user at the user interface. In this example, the user can select from three settings denoted LOW, MED, and HIGH. In this example, the LOW counterbalance setting will cause the algorithm to set the minimum counterbalance pressure to Min (User LOW), the MED counterbalance setting will cause the algorithm to set the minimum counterbalance pressure to Min (User MED), and the HIGH counterbalance setting will cause the algorithm to set the minimum counterbalance pressure to Min (User HIGH). The parameter “Longitudinal Slope” is the longitudinal slope value sensed by the slope sensor. The parameter “Lateral Slope” is the lateral slope value sensed by the slope sensor. The present example assumes that the “CB User Input” is set at MED, that the “Longitudinal Slope” sensed by the slope sensor is 10 degrees and the “Lateral Slope” sensed by the slope sensor is 10 degrees.

TABLE 3

| Outputs | Value |
|---|---|
| CB₁ applied at W₁ | 53% |
| CB₂ applied at W₂ | 0% |
| CB₃ applied at W₃ | 100% |

Table 3 summarizes the outputs of the example counterbalance algorithm shown above. The counterbalance value takes in the inputs described above and outputs a counterbalance pressure to each of the working assemblies. The output CB₁ is the counterbalance pressure to be applied to working assembly W₁, the output CB₂ is the counterbalance pressure to be applied to working assembly W₂, and the output CB₃ is the counterbalance pressure to be applied to working assembly W₃. In this example, the output CB: is 53%, the output CB₂ is 0%, and the output CB₃ is 100%, as shown in Table 3.

### Additional Inputs Including Traction Pressure, Slippage Indicators and GPS Input

Referring to FIG. 10, the control system 950 receives input from slope sensor 1054 and user interface 130 for executing the counterbalance algorithm. In some embodiments, the slope sensor is the only input to the control system. However, it should be understood that control system 950 could be set up to read as few as one input or as many inputs as are available to determine the optimal counterbalance setting. If control system 950 is simultaneously considering more than one input, control system 950 could have a prioritization schedule to determine the rank order of which inputs are more important and which are less important and how any conflicts in the relative actions recommended by the inputs should be resolved. In addition, if control system 950 accepts multiple inputs, then the operator could have a choice in being able to select which input or inputs control system 950 uses and which input or inputs control system 950 disregards. Additional inputs to be considered by the control system are described in detail below.

In various embodiments, the control system 950 can receive a traction pressure value as an input. In various embodiments, the traction pressure can be indicative of the traction of vehicle ground-engaging rotatable members 112 on the ground surface. The ground-working machine can be equipped with one or more pressure sensors and a traction drive circuit. The traction drive circuit can continuously output a traction pressure to the control system and the control system will continuously update the counterbalance values based on the traction pressure. In an embodiment, upon receiving increasingly low traction pressure values, the control system will output increasingly high counterbalance values to compensate for the decrease in traction pressure.

In various embodiments, the control system 950 can receive input indicative the slippage of vehicle ground-engaging rotatable members 112. The control system 950 can be operatively connected to one or more wheel slip sensors disposed on one or more of the vehicle ground-engaging rotatable members 112. The slip sensors are configured to detect wheel slippage relative to a non-slip condition. The slippage information received by the control system could then be used to variably control the counterbalance values set by the control system, providing higher counterbalance in higher slip conditions and lower counterbalance in lower slip conditions.

In various embodiments, the control system 950 can receive an input pertaining to the location of the ground-working machine 100 on the ground surface. The control system 950 can be operatively connected to one or more Global Positioning System (GPS) devices. The GPS can provide the control system with one or more inputs pertaining to the ground surface including the location of the ground-working machine on the ground surface, the type of terrain the ground-working machine is traversing (i.e., a flat surface such as a fairway or a tall grass area), the topography of the ground surface, and/or hazards associated with the ground surface (i.e., slippery surfaces or potholes). The control system can adjust the counterbalance values based on the location inputs received by the GPS. For instance, the control system can set a first counterbalance value for use on flat surfaces, another counterbalance value for use in uneven terrain, a third counterbalance value for use on hills, and so on.

In some embodiments, the control system 950 is configured to receive input from a Global Positioning System (GPS) instead of a slope sensor. In such embodiments, the control system can receive information relating to the GPS location of the ground-working machine, the topography of the mowing area, ground speed, and heading data. Such information can enable the control system to predict the slopes encountered by the ground-working machine pre-emptively.

### Downward Counterbalance Pressure

In some embodiments, the control system can be configured to control the connection assemblies to apply both upward and downward counterbalance pressures on the working assemblies, as opposed to just upward pressure. In such embodiments, a positive counterbalance pressure to be applied to working assemblies disposed uphill from the vehicle and a negative counterbalance pressure can be applied on working assemblies disposed downhill from the vehicle.

### Lateral Shifting

In various embodiments, additionally or alternatively to applying a counterbalance pressure to each of the working assemblies in response to sensed slope, the control system can be configured to laterally shift each of the working assemblies as a function of the sensed slope. Without being bound to a particular theory, it is believed that laterally shifting the working assemblies in an uphill direction, based on a sensed slope, improves both traction and stability of the ground working machine 100.

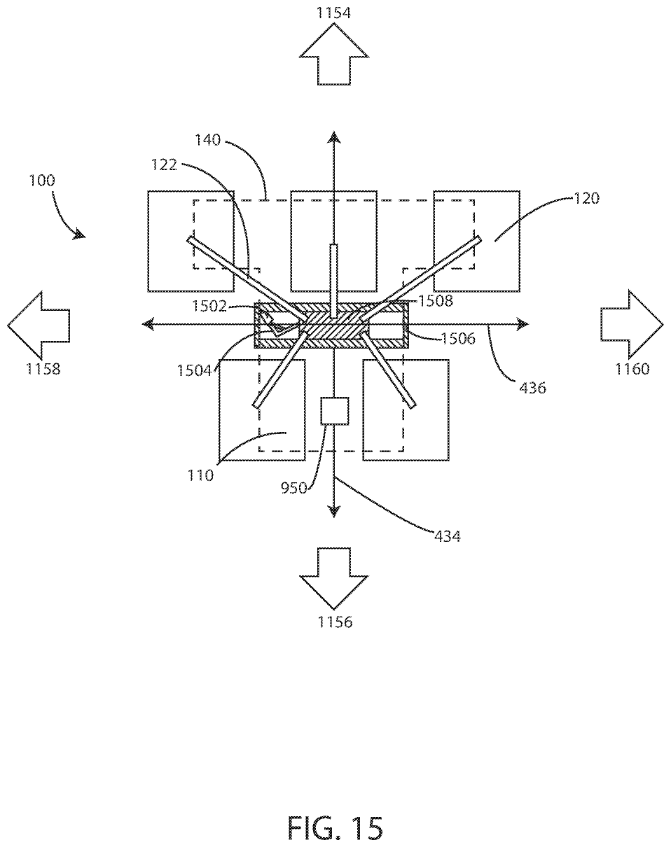

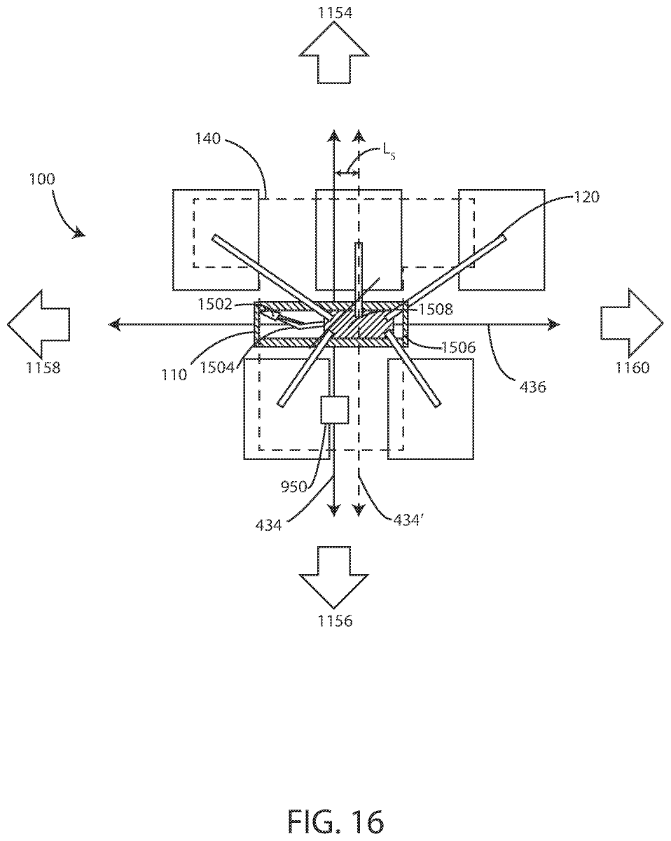

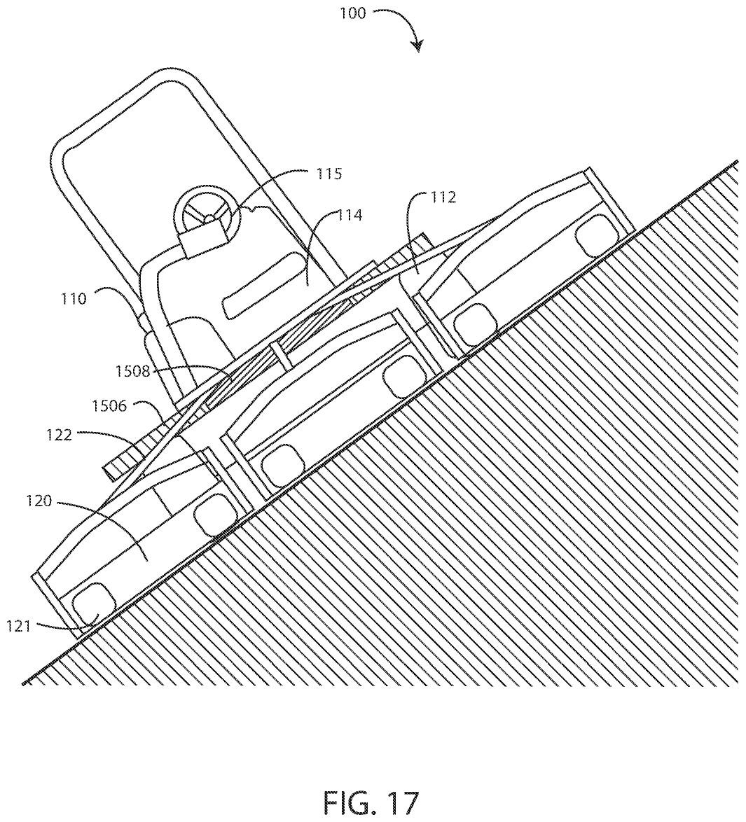

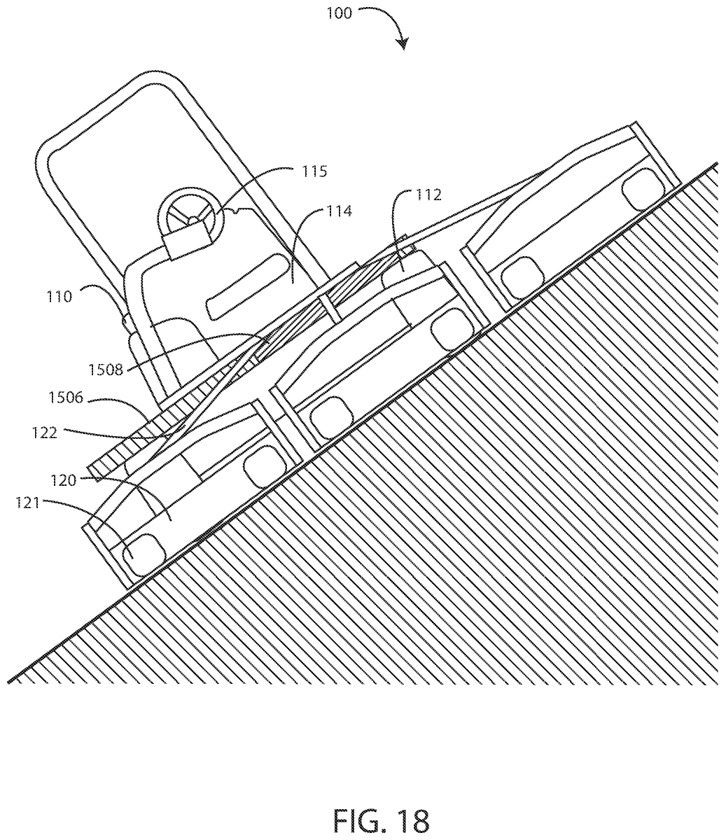

FIGS. 15-18 depict various examples of ground-working machine configured for lateral shifting. FIG. 15, depicts a schematic top view of a ground-working machine with no lateral shifting applied. FIG. 16, depicts a schematic top view of a ground-working machine with the working assemblies shifted to the right by amount L_{S}. FIG. 17 depicts a schematic front view of a ground-working machine on a sloped surface with no lateral shifting applied. FIG. 18, depicts a schematic front view of a ground-working machine on a sloped surface with the working assemblies shifted uphill, which is to the right from the perspective of the viewer.

Referring now to FIG. 15, a schematic view of a ground-working machine on a ground surface is shown in accordance with various embodiments herein. The ground-working machine 100 can have some of or all the features of the ground-working machines described previously but is drawn schematically for clarity. The ground-working machine 100 includes a vehicle 110 and five working assemblies 120. The ground-working machine can be defined by longitudinal axis 434 and lateral axis 436. Each working assembly 120 can be attached to the vehicle 110 with a connection assembly 122. FIG. 15 shows a ground-working machine with five working assemblies in a three-two configuration. However, the principles described herein apply to ground-working machines having other numbers of working assemblies or other configurations as described throughout the present application.

The ground-working machine 100 can further include a slope sensor (not shown in this view) and a control system 950 disposed on or within the vehicle 110 In various examples, the control system 950 is configured to receive a longitudinal slope value, a lateral slope value, or both from the slope sensor 1054. As previously described, the longitudinal slope value indicates a slope of the vehicle 110 along longitudinal axis 434 with respect to a horizontal reference plane and lateral slope value indicates a slope of the vehicle 110 along lateral axis 436 with respect to the direction of gravity.

In various embodiments, based on the slope value or slope values received from the slope sensor 1054, the control system 950 is configured to determine whether to laterally shift the working assemblies 120 with respect to the vehicle 110 and by how much. If a determination is made to laterally shift the working assemblies 120, the control system 950 is configured to determine a lateral shift value from a range of lateral shift values based on the slope value or slope values. The control system 950 is configured to apply a lateral shift value to each working assembly 120. In various embodiments, the working assembly ground-engaging rotatable members 121 of each working assembly 120 remain in contact with a ground surface while the determined lateral shift is applied. In this scenario, during the time that the working units are laterally shifted, the operator can drive the ground-working machine forward, to avoid any possible damage to the turf from the lateral shift motion of the working units. Alternatively, the working units can be in a raised position when a lateral shift is applied.

In various embodiments, the lateral shift values will be output by the control system 950 to an electrically controlled fluid power actuator 1502. In the embodiment of FIGS. 15 and 16, the fluid power actuator 748 is configured as a hydraulic cylinder, but other fluid power actuators and other actuators are conceivable such as a pneumatic cylinders, screw type electric actuators, or the like. In addition, other types of linear actuators can be used in place of the fluid power actuator 748 in various embodiments, such as screw actuators or piezoelectric actuators.

In various embodiments, the fluid power actuator 1502 has its base end pivotally connected to a support frame 1506 and has its rod end pivotally attached to scissors frame 1504. In various embodiments, the support frame 1506 is rigidly connected to vehicle 110 and the carrier frame 1508 is configured to slide laterally along the support frame. By extending and retracting fluid power actuator 1502, scissors frame 1504 is displaced. Displacement of scissors frame 1504 causes lateral motion of carrier frame 1508 along the support frame 1506. That is, by extending and retracting fluid power actuator 1502, the carrier frame 1508 and attached working assemblies 120 are laterally displaced with respect to the longitudinal axis 434 of vehicle 110.

In the embodiment of FIGS. 15 and 16, each of the working assemblies 120 are configured to be laterally shifted simultaneously and by the same amount with respect to the longitudinal axis 434 of vehicle 110. However, alternative arrangements are contemplated in which each working assembly 120 can be laterally shifted individually with respect to the longitudinal axis 434 of vehicle 110.

In various embodiments, the amount of lateral shifting applied to each working assembly 120 changes dynamically as a function of one or more factors including the slope value. The control system is configured to read the slope value from the slope sensor 1054 and adaptively laterally shift the working assemblies 120 continuously or at a set time interval. In various embodiments, the amount of lateral shifting applied to each working assembly 120 can vary between a minimum lateral shifting value and a maximum lateral shifting value. In various embodiments, the minimum lateral shifting value can correspond to no lateral shifting. In an embodiment, when no lateral shifting is applied, the working assemblies 120 are laterally centered with respect to the vehicle 110 and the carrier frame 1508 is laterally centered with respect to the support frame 1506 (see FIGS. 15 and 17). When a maximum amount of lateral shifting is applied, the working assemblies 120 are laterally offset to their fullest extent with respect to the vehicle 110. In an embodiment, maximum lateral shifting is reached when the carrier frame 1508 has reached either the leftmost or rightmost extent of the support frame 1506. In some embodiments, the maximum lateral shifting can correspond to a lateral displacement of the working assemblies with respect to the vehicle that is greater than or equal to 0.5 feet. 1.5 feet. 2.5 feet. 3.5 feet, or 4.0 feet, or can be an amount falling within a range between any of the foregoing.

FIGS. 16 and 18 depict an intermediate amount of lateral shifting, wherein the carrier frame 1508 is laterally shifted by amount L_{S}, which is between the lateral center and the uphill or rightmost boundary of the support frame 1506. In various embodiments, each of the possible lateral shift values falls within a lateral shifting range and the working assembly ground-engaging rotatable members 121.

In various embodiments, the amount of lateral shifting applied to the working assemblies 120 changes dynamically with the slope. In various embodiments, when the slope is below a threshold value, the lateral shifting value set for the working assemblies 120 will be a baseline amount of lateral shifting. In some embodiments, the baseline lateral shifting value can be zero (e.g., the working assemblies are laterally centered with respect to the longitudinal axis 434 of vehicle 110). In some embodiments, the threshold slope angle can be greater than or equal to zero, one, or two degrees with respect to a horizontal reference plane. In some embodiments, the threshold slope angle can be less than or equal to ten, six, or two degrees with respect to a horizontal reference plane. In some embodiments, the threshold slope angle can fall within a range of zero to ten degrees with respect to a horizontal reference plane, or one to six degrees with respect to a horizontal reference plane or can be about two degrees with respect to a horizontal reference plane.

The change in slope is a dynamic input to which the control system 950 responds. For instance, the lateral shifting applied to the working assemblies 120 increases as the lateral slope steepens until the maximum amount of lateral shifting has been achieved. Once the maximum amount of lateral shifting for the working assemblies 120 has been reached, steeper lateral slope values will not further increase the lateral shifting.

The impact of different ground conditions and corresponding slope inputs on lateral shifting will now be described. The schematic of FIGS. 15 and 16 will be referenced to describe how examples of the counterbalance system can respond to five different ground slope conditions: substantially flat, a forward uphill slope 1154, a rearward uphill slope 1156, a leftward uphill slope 1158, and a rightward uphill slope 1160.

### Substantially Flat

When the ground surface is relatively flat, the slope sensor will detect zero longitudinal slope and zero lateral slope. The slope sensor 1054 will then output a longitudinal slope value of zero and a lateral slope value of zero to the control system. Based on the input from the slope sensor, the control system 950 commands the fluid power actuator 1502 to laterally shift the cutting units to a particular lateral shifting value. In the embodiments of FIG. 15, the control system commands the fluid power actuator 1502 to apply zero lateral shifting to the working assemblies 120. In embodiments when the working assemblies 120 are already centered with respect to the vehicle 110 as the slope is detected (see FIGS. 15 and 17), the working assemblies will remain laterally centered with respect to the longitudinal axis 434 of the vehicle 110. Alternatively, if the working assemblies 120 are laterally offset from the vehicle (110) as the slope is detected (see FIGS. 16 and 18), the control system commands the fluid power actuator 1502 to laterally shift the cutting units to the lateral center of the vehicle 110.

### Forward Uphill and Rearward Uphill

If the vehicle is on a ground surface with a forward uphill slope 1154 and no lateral slope, the slope sensor 1054 will detect a positive longitudinal slope and zero lateral slope. The slope sensor 1054 will then output a positive longitudinal slope value and a lateral slope value of zero to the control system 950. If the vehicle is on a ground surface with a rearward uphill slope 1156 and no lateral slope, the slope sensor 1054 will detect a negative longitudinal slope and zero lateral slope. The slope sensor 1054 will then output a negative longitudinal slope value and a lateral slope value of zero to the control system 950. Based on the input from the slope sensor, the control system commands the fluid power actuator 1502 to laterally shift the cutting units to a particular lateral shifting value. In the embodiments of FIG. 15, the control system commands the fluid power actuator 1502 to apply zero lateral shifting to the working assemblies 120. In embodiments when the working assemblies 120 are already centered with respect to the vehicle 110 as the slope is detected (see FIGS. 15 and 17), the working assemblies will remain laterally centered with respect to the longitudinal axis 434 of the vehicle 110. Alternatively, if the working assemblies 120 are laterally offset from the vehicle (110) as the slope is detected (see FIGS. 16 and 18), the control system commands the fluid power actuator 1502 to laterally shift the cutting units to the lateral center of the vehicle 110.

### Leftward and Rightward Uphill

If the vehicle is on a surface with a rightward uphill slope 1160 and no longitudinal slope, the slope sensor 1054 will detect zero longitudinal slope and a positive lateral slope. The slope sensor 1054 will then output a longitudinal slope value of zero and a positive lateral slope value to the control system 950. Based on the input from the slope sensor, the control system commands the fluid power actuator 1502 to laterally shift the cutting units to a particular lateral shifting value. In the embodiment of FIG. 15, the control system commands the fluid power actuator 1502 laterally shift the cutting units to the right (laterally uphill from vehicle 110). Such shifting can be seen in the comparison between FIGS. 15 and 16.

If the vehicle is on a surface with a leftward uphill slope 1158 and no longitudinal slope, the slope sensor 1054 will detect zero longitudinal slope and a negative lateral slope. The slope sensor 1054 will then output a longitudinal slope value of zero and a negative lateral slope value to the control system 950. Based on the input from the slope sensor, the control system commands the fluid power actuator 1502 to laterally shift the cutting units to a particular lateral shifting value. In the embodiment of FIG. 15, the control system commands the fluid power actuator 1502 laterally shift the cutting units to the left (laterally uphill from vehicle 110).

To shift the working assemblies laterally to the right from a lateral center, the control system 950 directs hydraulic flow to extend carrier fluid power actuator 1502. As the fluid power actuator extends, it forces scissors frame 1504 to open (i.e., the scissors frame spreads). Such spreading can be seen in the difference between FIGS. 15 and 16 and between FIGS. 17 and 18. As the scissors frame 1504 opens, carrier frame 1508 (and thus, the attached working assemblies 120) moves to the right along support frame 1506. The control system may stop the travel of carrier frame 1508 at any intermediate position when an appropriate level of lateral shifting has been reached.

Upon detecting a decreasing lateral slope control system 950 the control system 950 directs hydraulic flow to retract carrier fluid power actuator 1502. Retraction of the fluid power actuator 1502 causes scissors frame 1504 to close pulling carrier frame 1508 toward the center side of vehicle 110. Once again, the control system may stop the travel of carrier frame 1508 at any intermediate position when the appropriate lateral shift has been reached.

To shift the working assemblies laterally to the left from a lateral center, the control system 950 directs hydraulic flow to retract carrier fluid power actuator 1502. As the fluid power actuator retracts, it forces scissors frame 1504 to close. As the scissors frame 1504 closes, carrier frame 1508 (and thus, the attached working assemblies 120) moves to the left along support frame 1506. The control system may stop the travel of carrier frame 1508 at any intermediate position when an appropriate level of lateral shifting has been reached.

Upon detecting a decreasing lateral slope control system 950 the control system 950 directs hydraulic flow to extend carrier fluid power actuator 1502. Extension of the fluid power actuator 1502 causes scissors frame 1504 to open pulling carrier frame 1508 toward the center side of vehicle 110. Once again, the control system may stop the travel of carrier frame 1508 at any intermediate position when the appropriate lateral shift has been reached.

### Simultaneous Longitudinal and Lateral Slope

The same reasoning applies to ground surfaces having non-zero values for both longitudinal and lateral slope values. For instance, if vehicle 110 were placed on a ground surface having both a leftward and a frontward uphill, the control system 950 would shift the working assemblies to the left as a function of the sensed lateral slope.

### Methods of Applying Counterbalance

Many different methods are contemplated herein, including, but not limited to, methods of making, methods of using, and the like. Aspects of system/device operation described elsewhere herein can be performed as operations of one or more methods in accordance with various embodiments herein.

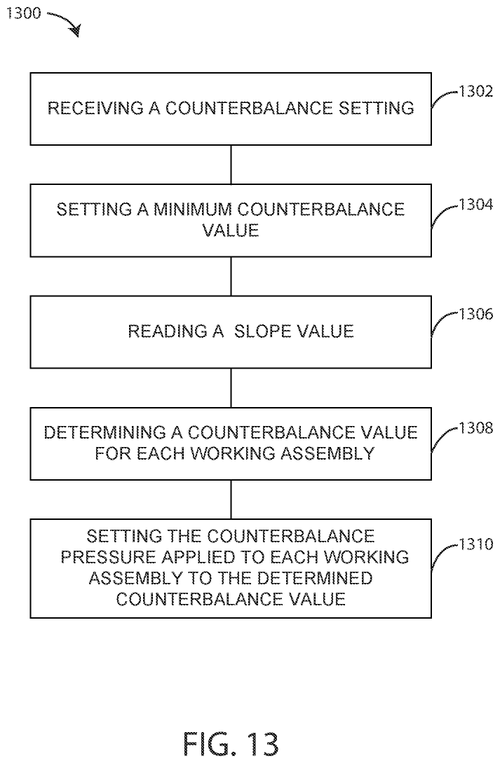

Referring now to FIG. 13, a method for operating a ground-working machine is shown in accordance with various embodiments herein. The ground-working machine can include a vehicle and a plurality of working assemblies. Each working assembly can be operatively connected to the vehicle by a connection assembly. Each connection assembly can be configured to apply a counterbalance pressure to the connected working assembly such that the counterbalance pressure shifts weight from the working assembly ground-engaging rotatable members to the vehicle ground-engaging rotatable members.

In various embodiments, method 1300 can include step 1302 of receiving a counterbalance setting. In various embodiments, the counterbalance setting can be set by a user on a counterbalance user interface. In some embodiments, the counterbalance setting determines a dynamic counterbalance range of the ground-working machine. In some embodiments, the dynamic counterbalance range is bounded by a minimum counterbalance value and a maximum counterbalance value. In some embodiments, the minimum counterbalance value can be determined by the counterbalance setting.

In various embodiments, method 1300 can include step 1304 setting a minimum counterbalance value. In various embodiments, the minimum counterbalance value is determined by the counterbalance setting.

In various embodiments, method 1300 can include step 1306 reading a slope value. In various embodiments, the slope value can be read from a slope sensor disposed on or within the vehicle. In various embodiments, reading the slope value can include reading a longitudinal slope value, reading a lateral slope value, or reading both a longitudinal and lateral slope value from a slope sensor.

In various embodiments, method 1300 can include step 1308 of determining a counterbalance value for each working assembly. In some embodiments the counterbalance value determined for each working assembly is based on one of the longitudinal slope values and the lateral slope value sensed by the slope sensor. In some embodiments the counterbalance value determined for each working assembly is based on the location of particular working assembly with respect to the vehicle.

In various embodiments, method 1300 can include step 1310 of setting the counterbalance pressure applied to each working assembly to the determined counterbalance value for the particular working assembly. In various embodiments, the minimum counterbalance value and the maximum counterbalance value span a counterbalance range. In various embodiments, the cutting assembly ground-engaging rotatable members of each of the working assemblies remain in contact with a ground surface over the counterbalance range.

### Methods of Applying an Operational Parameter

Many different methods are contemplated herein, including, but not limited to, methods of making, methods of using, and the like. Aspects of system/device operation described elsewhere herein can be performed as operations of one or more methods in accordance with various embodiments herein.

In various embodiments, operations described herein and method steps can be performed as part of a computer-implemented method executed by one or more processors of one or more computing devices. In various embodiments, operations described herein and method steps can be implemented instructions stored on a non-transitory, computer-readable medium that, when executed by one or more processors, cause a system to execute the operations and/or steps.

A method of operating a ground-working machine is described herein. The machine can include a vehicle and a plurality of working assemblies, each working assembly may be operatively connected to the vehicle by a connection assembly. The method can include reading a longitudinal slope value and a lateral slope value from the slope sensor. The method can include responsive to at least the reading of the lateral slope value, determining an operational parameter related to at least one of the working assemblies. In various embodiments, determining the operational parameter includes at least one of determining a counterbalance pressure applied to each working assembly, and a lateral shift value applied to each of the working assemblies.

Determining the counterbalance pressure applied to each working assembly can include receiving a counterbalance setting on a counterbalance user interface, wherein each connection assembly is configured to apply the counterbalance pressure to the connected working assembly, wherein the counterbalance pressure shifts weight from the working assembly ground-engaging rotatable members to the vehicle ground-engaging rotatable members. Determining the counterbalance pressure applied to each working assembly can include setting a minimum counterbalance value, wherein the minimum counterbalance value is determined by the counterbalance setting. Determining the counterbalance pressure applied to each working assembly can include determining a counterbalance value for each working assembly based on at least the longitudinal slope value and the lateral slope value and based on a location of the particular working assembly with respect to the vehicle. Determining the counterbalance pressure applied to each working assembly can include setting the counterbalance pressure applied to each working assembly to the determined counterbalance value for the particular working assembly. The minimum counterbalance value and the maximum counterbalance value can span a counterbalance range. The working assembly ground-engaging rotatable members remain in contact with a ground surface over the counterbalance range.

Determining a lateral shift value of at least one working assembly can include determining the lateral shift value from a range of lateral shift values for each working assembly based on at least the lateral slope value. Determining a lateral shift value of at least one working assembly can include laterally shifting the position of each working assembly with respect to the longitudinal axis of the vehicle to the determined lateral shift value, wherein each of the possible lateral shift values falls within a lateral shifting range.

In an embodiment, the method can further include upon reading a lateral slope value that is at or above a threshold slope, laterally shifting each working assembly uphill with respect to the vehicle.

In an embodiment, the method can further include laterally shifting each working assembly by the same amount with respect to the longitudinal axis of the vehicle.

In an embodiment of the method, each connection assembly is connected to a carrier frame, wherein the carrier frame is configured to be laterally displaced relative to a support frame which is rigidly attached to the vehicle. The method can include laterally shifting the position of each working assembly comprises laterally shifting the carrier frame with respect to the support frame. In an embodiment of the method, the carrier frame is configured to be laterally displaced relative to the support frame using an electrically controlled fluid power actuator.

In an embodiment, the method can further include reading a slope value that is at or above a threshold slope value, setting an uphill counterbalance value for an uphill one of the plurality of working assemblies disposed above the vehicle on the slope, and setting a downhill counterbalance pressure for a working assembly disposed below the vehicle on the slope, wherein the uphill counterbalance value is higher than the downhill counterbalance pressure. In an embodiment of the method, the threshold slope is zero. In an embodiment of the method, the threshold slope is greater than or equal to two degrees with respect to a horizontal reference plane.

In an embodiment of the method, a first working assembly of the plurality of working assemblies is disposed left of a lateral center of the vehicle, and wherein a second working assembly of the plurality of working assemblies is disposed right of a lateral center of the vehicle. The method can include reading a lateral slope value sensed by the slope sensor, setting a downhill counterbalance value for a working assembly disposed vertically beneath the vehicle on the lateral slope, and setting an uphill counterbalance value for a working assembly disposed vertically above the vehicle on the lateral slope, wherein the uphill counterbalance value is higher than the downhill counterbalance value.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed, and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1.-30. (canceled)

31. A ground-working machine comprising:
a. a vehicle comprising a plurality of vehicle ground-engaging rotatable members configured to contact a ground surface;
b. a plurality of working assemblies, each working assembly comprising a ground-working unit and a plurality of working assembly ground-engaging rotatable members configured to contact the ground surface;
c. a plurality of connection assemblies, wherein each connection assembly attaches one working assembly to the vehicle, each connection assembly having a first end attached to the one working assembly and a second end attached to the vehicle, each connection assembly configured to apply a counterbalance pressure to the one working assembly, wherein the counterbalance pressure shifts weight from the working assembly ground-engaging rotatable members to the vehicle ground-engaging rotatable members; and
d. a control system comprising a slope sensor configured to output a slope value indicating a slope of the ground-working machine with respect to a horizontal reference plane, wherein the control system is configured to:
i. based on the slope value, determine whether to apply a counterbalance pressure or change an already-applied counterbalance pressure to each of the working assemblies via its connection assembly;
ii. if a determination is made to apply or change a counterbalance pressure at a particular working assembly, determine a counterbalance value based on the slope value and a location of the particular working assembly with respect to the vehicle; and
iii. apply a counterbalance pressure of the determined counterbalance value via a connection assembly to each particular working assembly for which a determination was made to apply or change a counterbalance pressure, wherein the working assembly ground-engaging rotatable members remain in contact with a ground surface while the determined counterbalance pressure of the determined counterbalance value is applied to the particular working assembly.

32. The machine of claim 1, wherein the applied counterbalance pressure causes a lift force to be applied to each working particular assembly for which the determination was made to apply or change the counterbalance pressure.

33. The machine of claim 1, wherein each connection assembly comprises:
a. a connector arm attached to the working assembly at a first end and to the vehicle at a second end;
b. a fluid power actuator attached to the connector arm at a first end and to the vehicle at a second end;
c. a counterbalance valve operatively connected to the fluid power actuator and configured to apply the counterbalance pressure to the one working assembly via the fluid power actuator; and
d. a lift valve operatively connected to the fluid power actuator and configured to apply a lift pressure to the one working assembly to move the connection assembly to a raised position not contacting the ground surface; and
wherein the ground-working machine further comprises a lift interface configured to receive input from a user requesting movement of one or more of the working assemblies to a raised position.

34. The machine of claim 1, wherein upon reading a slope value that is at or above a threshold slope, the control system is further configured to:
set an uphill counterbalance value for an uphill one of the plurality of working assemblies disposed above the vehicle on the slope; and
set a downhill counterbalance pressure for a working assembly disposed below the vehicle on the slope, wherein the uphill counterbalance value is higher than the downhill counterbalance pressure.

35. The machine of claim 4, wherein the threshold slope is zero.

36. The machine of claim 1, wherein a first working assembly of the plurality of working assemblies is disposed left of a lateral center of the vehicle, and wherein a second working assembly of the plurality of working assemblies is disposed right of a lateral center of the vehicle.

37. The machine of claim 6, wherein the control system is configured to read a lateral slope value sensed by the slope sensor and set a downhill counterbalance value for a working assembly disposed vertically beneath the vehicle on the lateral slope and set an uphill counterbalance value for a working assembly disposed vertically above the vehicle on the lateral slope, wherein the uphill counterbalance value is higher than the downhill counterbalance value.

38. The machine of claim 1, the control system comprising a counterbalance interface configured to receive a counterbalance setting from a user, wherein the counterbalance setting determines a dynamic counterbalance range.

39. The machine of claim 8, wherein the dynamic counterbalance range comprises a minimum counterbalance value and a maximum counterbalance value, wherein the minimum counterbalance value is determined by the counterbalance setting.

40. The machine of claim 9, the counterbalance setting comprising a selection from a low counterbalance setting and a high counterbalance setting, wherein the low counterbalance setting has a lower minimum counterbalance value than the high counterbalance setting, and wherein the low counterbalance setting and the high counterbalance setting have the same maximum counterbalance value.

41. The machine of claim 9, wherein the minimum counterbalance value is greater than zero.

42. The machine of claim 1, the control system further comprising a global positioning system (GPS) device, wherein the control system is configured to:
receive information on at least one of: topography of the ground surface, ground speed, and heading data from the GPS device; and
based on the received information, determine whether to apply a counterbalance pressure or change the already-applied counterbalance pressure to each of the working assemblies.

43. The machine of claim 1, wherein the control assembly is configured to receive a longitudinal slope value and lateral slope value from the slope sensor.

44. The machine of claim 1, wherein each connection assembly is configured to raise the one working assembly from a working position in which the working assembly ground-engaging rotatable members remain in contact with a ground surface to a raised position in which the working assembly ground-engaging rotatable members are raised above the ground surface.

45. The machine of claim 1, wherein the working assembly ground-engaging rotatable members are configured to follow the ground surface independently of the vehicle ground-engaging rotatable members.

46. The machine of claim 1, wherein each connection assembly is further configured to apply a downward pressure to the one working assembly, wherein the downward pressure shifts weight from the vehicle ground-engaging rotatable members to the working assembly ground-engaging rotatable members.

47. The machine of claim 1, wherein the slope sensor is configured to output a time series of slope values and the control system is configured to calculate a rolling average slope value over the time series of slope values.

48. A machine comprising:
a vehicle comprising a plurality of vehicle ground-engaging rotatable members configured to contact a ground surface;
a first working assembly disposed to the left of a lateral center of the vehicle and comprising a plurality of first working assembly ground-engaging rotatable members configured to contact the ground surface;
a first connection assembly connecting the first working assembly to the vehicle and configured to apply a first counterbalance pressure to the first working assembly, wherein the first counterbalance pressure shifts weight from the first working assembly ground-engaging rotatable members to the vehicle ground-engaging rotatable members;
a second working assembly disposed to the right of the lateral center of the vehicle and comprising a plurality of second working assembly ground-engaging rotatable members configured to contact the ground surface;
a second connection assembly connecting the second working assembly to the vehicle and configured to apply a second counterbalance pressure to the second working assembly, wherein the second counterbalance pressure shifts weight from the second cutting assembly ground-engaging rotatable members to the vehicle ground-engaging rotatable members;
a control system comprising a slope sensor, wherein the control system is configured to:
read a slope value from the slope sensor;
determine a first counterbalance value for the first working assembly;
determine a second counterbalance value for the second working assembly;
set the first counterbalance pressure applied to the first working assembly at the first counterbalance value;
set the second counterbalance pressure applied to the second working assembly at the second counterbalance value;
wherein the counterbalance values are determined as a function of the slope value and the location of the particular working assembly with respect to the vehicle, and wherein each counterbalance value falls within a counterbalance range, and wherein the first cutting assembly and the second cutting assembly remain in contact with a ground surface over the counterbalance range.

49. The machine of claim 18, wherein each connection assembly comprises:
a. a connector arm attached to the working assembly at a first end and to the vehicle at a second end;
b. a fluid power actuator attached to the connector arm at a first end and to the vehicle at a second end;
c. a counterbalance valve operatively connected to the fluid power actuator and configured to apply the counterbalance pressure to the one working assembly via the fluid power actuator; and
d. a lift valve operatively connected to the fluid power actuator and configured to apply a lift pressure to the one working assembly to move the connection assembly to a raised position not contacting the ground surface; and
wherein the ground-working machine further comprises a lift interface configured to receive input from a user requesting movement of one or more of the working assemblies to a raised position.

50. A method of operating a ground-working machine, the machine comprising a vehicle and a plurality of working assemblies, each working assembly operatively connected to the vehicle by a connection assembly, wherein each connection assembly is configured to apply a counterbalance pressure to the connected working assembly, wherein the counterbalance pressure shifts weight from the working assembly ground-engaging rotatable members to the vehicle ground-engaging rotatable members, the method comprising:
receiving a counterbalance setting on a counterbalance user interface;
setting a minimum counterbalance value, wherein the minimum counterbalance value is determined by the counterbalance setting;
reading a longitudinal slope value and a lateral slope value from the slope sensor; and
determining a counterbalance value for each working assembly based on at least the longitudinal slope value and the lateral slope value and based on a location of the particular working assembly with respect to the vehicle;
setting the counterbalance pressure applied to each working assembly to the determined counterbalance value for the particular working assembly;
wherein the minimum counterbalance value and the maximum counterbalance value span a counterbalance range, and wherein the working assembly ground-engaging rotatable members remain in contact with a ground surface over the counterbalance range.
